(19) United States
(12) Patent Application Publication
(10) Pub. No.: US 2024/0043634 A1
(43) Pub. Date: Feb. 8, 2024

(54) PRECURSOR, POLYMER, OPTICAL FILM COMPRISING POLYMER, AND DISPLAY DEVICE COMPRISING OPTICAL FILM

(71) Applicant: KOLON INDUSTRIES, INC., Seoul (KR)

(72) Inventors: Jong Won YANG, Seoul (KR); Hyo Jun PARK, Seoul (KR); Hak-Gee Jung, Seoul (KR)

(21) Appl. No.: 18/246,754

(22) PCT Filed: Dec. 28, 2021
(86) PCT No.: PCT/KR2021/020020

§ 371 Date: Mar. 27, 2023

(30) Foreign Application Priority Data
Dec. 30, 2020 (KR) 10-200-0188257
Dec. 28, 2021 (KR) 10-2021-0189290

(51) Int. Cl. C08J 5/18; C08G 73/14; C08G 73/12

(52) U.S. Cl. CPC C08J 5/18; C08G 73/14; C08G 73/123; G02B 1/04

(57) ABSTRACT

The present invention relates to a polyamide-imide based precursor, a polymer prepared from the precursor, an optical film comprising the polymer, and a display device comprising the optical film. A polymer according to an embodiment of the present invention comprises amide repeating units and imide repeating units that are disposed uniformly and alternately, and an optical film comprising such a polymer can exhibit excellent light transmittance, a low yellow index (Y.I), and superb stability.

### TECHNICAL FIELD

The present disclosure relates to a precursor, a polymer, an optical film containing the polymer, and a display device including the optical film.

### BACKGROUND ART

Recently, the use of an optical film instead of glass as a cover window of a display device has been considered with the goal of reducing the thickness and weight of the display device and increasing the flexibility thereof. In order for the optical film to be usable as a cover window of a display device, the optical film should have excellent optical and mechanical properties. In addition, in order to protect the display device and prevent deterioration in the visibility of the display device during use, the optical film should exhibit optical stability and mechanical stability.

Accordingly, research is underway on optical films having excellent optical properties, mechanical properties, and stability and polymers for producing such optical films.

### DISCLOSURE

### Technical Problem

Therefore, the present disclosure has been made in view of the above problems, and it is one object of the present disclosure to provide an optical film having excellent optical properties.

It is another object of the present disclosure to provide an optical film that has excellent light transmittance and a low yellowness index (Y.I.) since it contains a polymer including amide repeating units and imide repeating units, which are regularly and alternately arranged.

It is another object of the present disclosure to provide an optical film that has excellent chemical and optical stability because it has a low chlorine (Cl) concentration.

It is another object of the present disclosure to provide a polymer for manufacturing an optical film having excellent optical properties and stability.

It is another object of the present disclosure to provide a polymer including amide repeating units and imide repeating units, which are regularly and alternately arranged, and a precursor for preparing the polymer.

It is another object of the present disclosure to provide a display device including the optical film having excellent optical properties and stability.

### Technical Solution

In accordance with the present disclosure, the above and other objects can be accomplished by the provision of an optical film containing a polymer having a first polymerization structure represented by the following Formula 1:

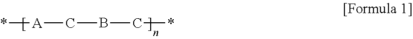

wherein A is a group derived from a dianhydride compound, B is a group derived from a dicarbonyl compound, C is a group derived from a diamine compound, and n represents the number of repetitions of *-A-C—B—C—*, which is the repeating unit, and is an integer of 5 or more.
n may be an integer of 10 or more.

The content of the first polymerization structure may be 5% by weight or more based on the total weight of the optical film.

The content of the first polymerization structure may be 10% by weight or more based on the total weight of the optical film.

The dicarbonyl compound may be selected from terephthaloyl dichloride (TPC), isophthaloyl chloride (IPC), naphthalene-2,6-dicarbonyl dichloride, naphthalene-2,3-dicarbonyl dichloride, 1,1′-biphenyl-4,4′-dicarbonyl dichloride, 1,1′-biphenyl-3,3′-dicarbonyl dichloride, and 4,4′-oxydibenzoylchloride (ODBC).

The diamine compound may be selected from 2,2′-bis(trifluoromethyl)benzidine (TFDB), oxydianiline (ODA), p-phenylenediamine (pPDA), m-phenylenediamine (mPDA), 4,4-methylenedianiline (pMDA), 3,3-methylenedianiline (mMDA), 1,3-bis(3-aminophenoxy)benzene (133APB), 1,3-bis(4-aminophenoxy)benzene (134APB), bisaminophenoxy phenyl hexafluoropropane (4BDAF), 2,2′-bis(3-aminophenyl) hexafluoropropane (33-6F), 2,2′-bis(4-aminophenyl) hexafluoropropane (44-6F), bis(4-aminophenyl)sulfone (ODDS), bis(3-aminophenyl)sulfone (3DDS), 1,3-cyclohexanediamine (13CHD), 1,4-cyclohexanediamine (14CHD), 2,2-bis(4-(4-aminophenoxy)phenyl)propane (6HMDA), 2,2-bis(3-amino-4-hydroxyphenyl)hexafluoropropane (DBOH), bis(4-(4-aminophenoxy)phenyl)sulfone, bis(4-(3-aminophenoxy)phenyl)sulfone, 9,9-bis(4-aminophenyl)fluorene (FDA) and 9,9-bis(4-amino-3-fluorophenyl)fluorene (F-FDA).

The dianhydride compound may include at least one selected from 2,2-bis(3,4-dicarboxyphenyl)hexafluoropropane dianhydride (6FDA), 3,3′,4,4′-biphenyltetracarboxylic dianhydride (BPDA), 4-(2,5-dioxotetrahydrofuran-3-yl)-1,2,3,4-tetrahydronaphthalene-1,2-dicarboxylic anhydride (TDA), pyromellitic dianhydride (PMDA), benzophenone tetracarboxylic dianhydride (BTDA), 4,4′-oxydiphthalic anhydride (ODPA), 4,4′-bis(3,4-dicarboxyphenoxy)-diphenyl sulfide dianhydride (BDSDA), 3,3′,4,4′-diphenylsulfonetetracarboxylic dianhydride (SO₂DPA), 4,4′-(4,4′-isopropylidenediphenoxy)bis(phthalic anhydride) (6HBDA), cyclobutane-1,2,3,4-tetracarboxylic dianhydride (CBDA), 1,2,3,4-cyclopentane-tetracarboxylic dianhydride (CPDA), 1,2,4,5-cyclohexane-tetracarboxylic dianhydride (CHDA), and dicyclohexyl-3,4,3′,4′-tetracarboxylic dianhydride (HBPDA).

The first polymerization structure may include a repeating unit represented by the following Formula 2:

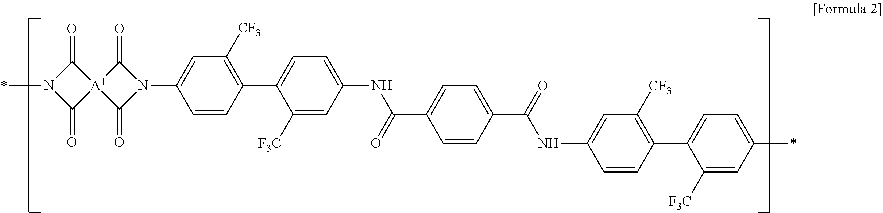

wherein A¹ represents a tetravalent organic group.
A¹ may be represented by at least one of the following Formulas 3 to 12:

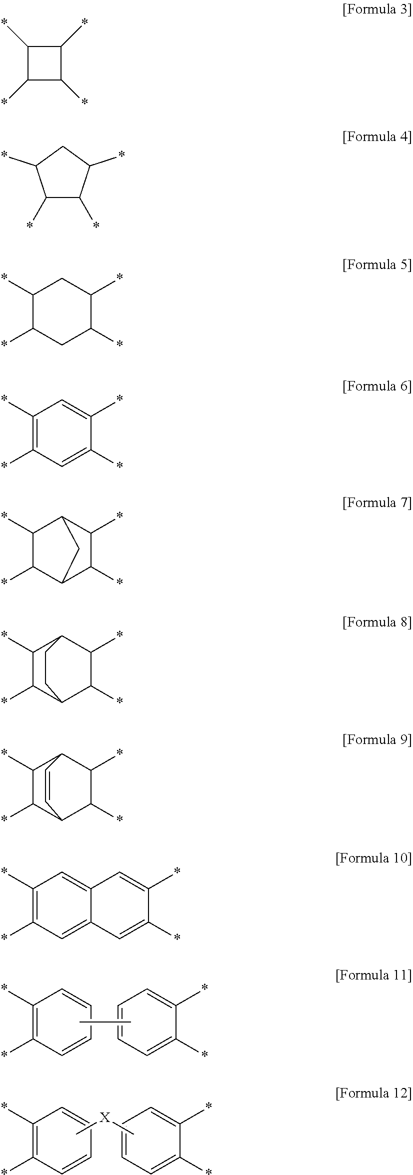

wherein X represents any one of —O—, —S—, —SO₂—, —CO—, —(CH₂)ₙ—, —C(CH₃)₂—, and —C(CF₃)₂—.

The first polymerization structure may include a repeating unit represented by any one of the following Formulas 13, 14, and 15:

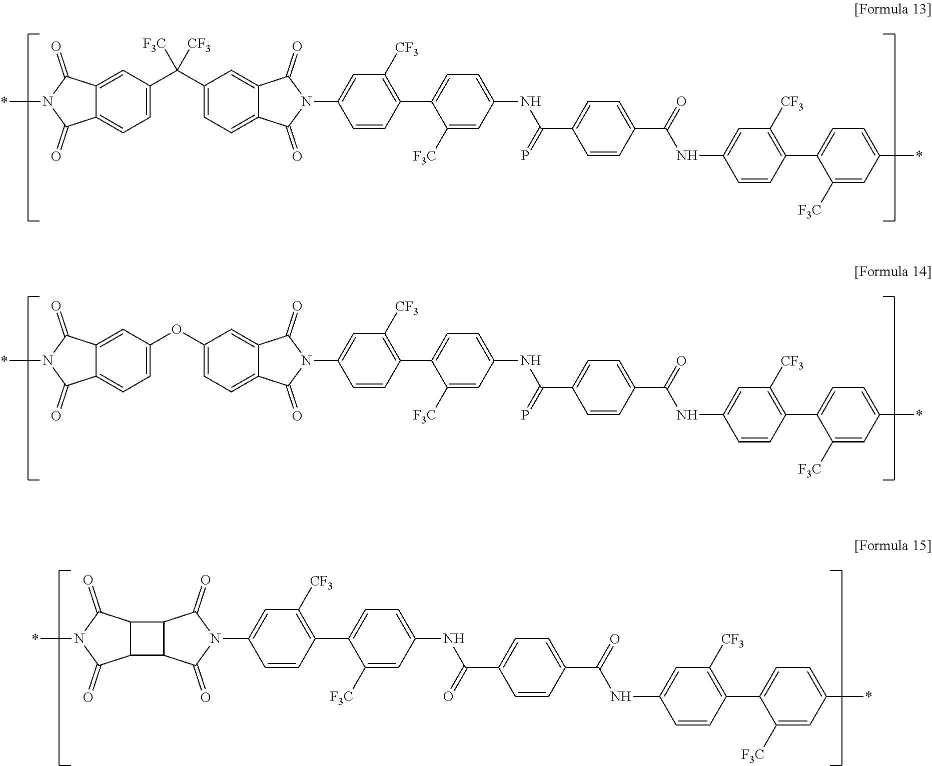

The first polymerization structure may b e formed by polymerization of the dianhydride compound and a diamine compound represented by the following Formula 16:

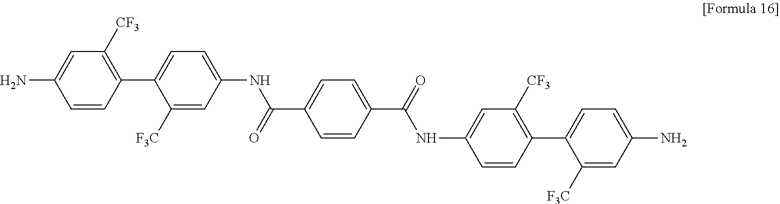 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

The optical film may contain 100 ppb (parts per billion) by weight or less of chlorine (Cl).

The optical film may have a light transmittance of 88% or more based on a thickness of 50 μm.

The optical film may have a yellowness index of 4 or less based on a thickness of 50 μm.

The polymer may have a polydispersity index (PDI) of 1.5 to 3.0.

In accordance with another aspect of the present disclosure, there is provided a display device including the optical film.

In accordance with another aspect of the present disclosure, there is provided a polymer including a first polymerization structure represented by the following Formula 1:

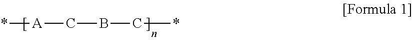

In accordance with another aspect of the present disclosure, there is provided a polymer resin including the polymer.

In accordance with another aspect of the present disclosure, there is provided a polyamide-imide precursor having a repeating unit represented by the following Formula 18:

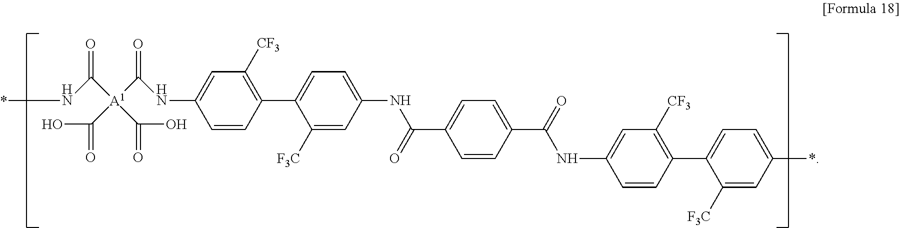

### Advantageous Effects

The polymer according to an embodiment of the present disclosure can be used to manufacture an optical film having excellent optical properties and stability, since it contains a polymer including amide repeating units and imide repeating units, which are regularly and alternately arranged.

The optical film has excellent light transmittance and a low yellowness index (Y.I.) since it contains a polymer including amide repeating units and imide repeating units, which are regularly and alternately arranged.

In addition, according to an embodiment of the present disclosure, little or no hydrochloric acid (HCl) or chlorine (Cl) is generated during the polymerization of the monomer for manufacturing the optical film. The optical film according to an embodiment of the present disclosure contains little or no chlorine (Cl), and thus has excellent stability.

The display device including an optical film according to an embodiment of the present disclosure has excellent display quality and is capable of maintaining excellent display quality even after use for a long time.

### DESCRIPTION OF DRAWINGS

FIG. 1 is a cross-sectional view illustrating a part of display device according to an embodiment of the present disclosure; and

FIG. 2 is an enlarged cross-sectional view illustrating part “P” of FIG. 1.

### BEST MODE

Hereinafter, embodiments of the present disclosure will be described in detail with reference to the accompanying drawings. However, the following embodiments are illustratively provided merely for clear understanding of the present disclosure, and do not limit the scope of the present disclosure.

The shapes, sizes, ratios, angles, and numbers disclosed in the drawings for describing embodiments of the present disclosure are merely examples, and the present disclosure is not limited to the illustrated details. Like reference numerals refer to like elements throughout the present specification. In the following description, when a detailed description of relevant known functions or configurations is determined to unnecessarily obscure important points of the present disclosure, the detailed description will be omitted.

In the case in which the term such as “comprise”, “have”, or “include” is used in the present specification, another part may also be present, unless “only” is used. Terms in a singular form may include the plural meanings, unless noted to the contrary. Also, in construing an element, the element is to be construed as including an error range even if there is no explicit description thereof.

In describing a positional relationship, for example, when the positional relationship is described as “on”, “above”, “below”, or “next”, the case of no contact therebetween may be included, unless “just” or “directly” is used.

Spatially relative terms, such as “below”, “beneath”, “lower”, “above”, and “upper”, may be used herein to describe the relationship between a device or element and another device or element, as shown in the figures. It will be understood that spatially relative terms are intended to encompass different orientations of a device during the use or operation of the device, in addition to the orientation depicted in the figures. For example, if a device in one of the figures is turned upside down, elements described as “below” or “beneath” other elements would then be positioned “above” the other elements. The exemplary term “below” or “beneath” can, therefore, encompass the meanings of both “below” and “above”. In the same manner, the exemplary term “above” or “upper” can encompass the meanings of both “above” and “below”.

In describing temporal relationships, for example, when a temporal order is described using “after”, “subsequent”, “next”, or “before”, the case of a non-continuous relationship may be included, unless “just” or “directly” is used.

It will be understood that, although the terms “first”, “second”, etc. may be used herein to describe various elements, these elements are not limited by these terms. These terms are only used to distinguish one element from another. Therefore, a first element could be termed a second element within the technical idea of the present disclosure.

It should be understood that the term “at least one” includes all combinations related with one or more items. For example, “at least one among a first element, a second element, and a third element” may include all combinations of two or more elements selected from among the first, second, and third elements, as well as each of the first, second, and third elements.

Features of various embodiments of the present disclosure may be partially or completely coupled to or combined with each other, and may be variously interoperated with each other and driven technically. The embodiments of the present disclosure may be carried out independently from each other, or may be carried out together in an interrelated manner.

An embodiment of the present disclosure provides an optical film. The optical film according to the embodiment of the present disclosure contains a polymer. The polymer comprises, for example, a polymerized compound. The optical film according to an embodiment of the present disclosure contains a polymer resin.

The optical film according to an embodiment of the present disclosure may include an imide repeating unit and an amide repeating unit.

The optical film according to an embodiment of the present disclosure may contain a polyamide-imide polymer. However, the embodiment of the present disclosure is not limited thereto, and the optical film according to an embodiment of the present disclosure may further contain at least one of a polyimide polymer and a polyamide polymer, in addition to the polyamide-imide polymer, and may further contain other polymers.

The optical film according to an embodiment of the present disclosure may be a polyamide-imide-based film. However, the embodiment of the present disclosure is not limited thereto, and the optical film according to an embodiment of the present disclosure may be a film that further includes a polymer other than the polyamide-imide polymer.

The optical film according to an embodiment of the present disclosure contains a polymer having a first polymerization structure represented by the following Formula 1:

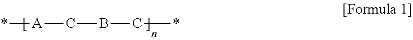

wherein A is a group derived from a dianhydride compound, B is a group derived from a dicarbonyl compound, C is a group derived from a diamine compound, and n represents the number of repetitions of *-A-C—B—C—*, which is the repeating unit, and is an integer of 5 or more.

According to an embodiment of the present disclosure, the first polymerization structure has a repeating unit represented by the following Reference Formula 1:

*-A-C—B—C—* [Reference Formula 1]
wherein A, B, C and D are the same as in Formula 1.

According to an embodiment of the present disclosure, the first polymerization structure may be formed by repeating the repeating unit, represented by Reference Formula 1, 5 times or more.

According to an embodiment of the present disclosure, n in Formula 1 may be an integer of 10 or more. In this case, the first polymerization structure may be formed by repeating the repeating unit, represented by Reference Formula 1, 10 times or more.

According to an embodiment of the present disclosure, n in Formula 1 may be an integer of 20 or more. In this case, the first polymerization structure may be formed by repeating the repeating unit, represented by Reference Formula 1, 20 times or more.

According to an embodiment of the present disclosure, n in Formula 1 may be an integer of 100 or more. In this case, the first polymerization structure may be formed by repeating the repeating unit, represented by Reference Formula 1, 100 times or more.

According to an embodiment of the present disclosure, the content of the first polymerization structure may be 5% by weight or more based on the total weight of the optical film. In addition, according to an embodiment of the present disclosure, the content of the first polymerization structure may be 10% by weight or more based on the total weight of the optical film.

Further, according to an embodiment of the present disclosure, the content of the first polymerization structure may be 20% by weight or more, 50% by weight or more, 70% by weight or more, 80% by weight or more, or 90% by weight or more, based on the total weight of the optical film.

According to an embodiment of the present disclosure, B in Formula 1 is a group derived from a dicarbonyl compound. According to an embodiment of the present disclosure, the dicarbonyl compound may be selected from terephthaloyl dichloride (TPC), isophthaloyl chloride (IPC), naphthalene-2,6-dicarbonyl dichloride, naphthalene-2,3-dicarbonyl dichloride, 1,1′-biphenyl-4,4′-dicarbonyl dichloride, 1,1′-biphenyl-3,3′-dicarbonyl dichloride, and 4,4′-oxydibenzoylchloride (ODBC).

According to an embodiment of the present disclosure, the dicarbonyl compound may be terephthaloyl dichloride (TPC).

According to an embodiment of the present disclosure, C in Formula 1 is a group derived from a diamine compound. According to an embodiment of the present disclosure, the diamine compound may be selected from 2,2′-bis(trifluoromethyl)benzidine (TFDB), oxydianiline (ODA), p-phenylenediamine (pPDA), m-phenylenediamine (mPDA), 4,4-methylenedianiline (pMDA), 3,3-methylenedianiline (mMDA), 1,3-bis(3-aminophenoxy)benzene (133APB), 1,3-bis(4-aminophenoxy)benzene (134APB), bisaminophenoxy phenyl hexafluoropropane (4BDAF), 2,2′-bis(3-aminophenyl) hexafluoropropane (33-6F), 2,2′-bis(4-aminophenyl) hexafluoropropane (44-6F), bis(4-aminophenyl)sulfone (4DDS), bis(3-aminophenyl)sulfone (3DDS), 1,3-cyclohexanediamine (13CHD), 1,4-cyclohexanediamine (14CHD), 2,2-bis(4-(4-aminophenoxy)phenyl)propane (6HMDA), 2,2-bis(3-amino-4-hydroxyphenyl)hexafluoropropane (DBOH), bis(4-(4-aminophenoxy)phenyl)sulfone, bis(4-(3-aminophenoxy)phenyl)sulfone, 9,9-bis(4-aminophenyl)fluorene (FDA), and 9,9-bis(4-amino-3-fluorophenyl)fluorene (F-FDA).

According to an embodiment of the present disclosure, the diamine compound may be 2,2′-bis(trifluoromethyl)benzidine (TFDB).

According to an embodiment of the present disclosure, an amide repeating unit is formed by B and C in Formula 1.

For example, B and C of Formula 1 are bonded to each other to form —B—C—, that is, an amide repeating unit according to Reference Formula 2.

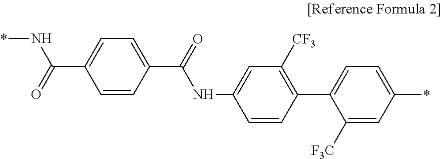

Alternatively, B and C of Formula 1 may be bonded to each other to form —C—B—, that is, an amide repeating unit according to Reference Formula 3.

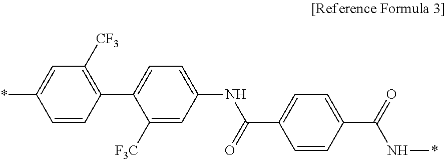

According to an embodiment of the present disclosure, A in Formula 1 is a group derived from a dianhydride compound.

According to an embodiment of the present disclosure, the dianhydride compound may include at least one selected from 2,2-bis(3,4-dicarboxyphenyl)hexafluoropropane dianhydride (6FDA), 3,3′,4,4′-biphenyltetracarboxylic dianhydride (BPDA), 4-(2,5-dioxotetrahydrofuran-3-yl)-1,2,3,4-tetrahydronaphthalene-1,2-dicarboxylic anhydride (TDA), pyromellitic dianhydride (PMDA), benzophenone tetracarboxylic dianhydride (BTDA), 4,4′-oxydiphthalic anhydride (ODPA), 4,4′-bis(3,4-dicarboxyphenoxy)-diphenyl sulfide dianhydride (BDSDA), 3,3′,4,4′-diphenylsulfonetetracarboxylic dianhydride (SO₂DPA), 4,4′-(4,4′-isopropylidenediphenoxy)bis(phthalic anhydride) (6HBDA), cyclobutane-1,2,3,4-tetracarboxylic dianhydride (CBDA), 1,2,3,4-cyclopentane-tetracarboxylic dianhydride (CPDA), 1,2,4,5-cyclohexane-tetracarboxylic dianhydride (CHDA), and dicyclohexyl-3,4,3′,4′-tetracarboxylic dianhydride (HBPDA).

According to an embodiment of the present disclosure, one type of dianhydride compound may be applied to A of Formula 1, and two or more types of dianhydride compounds may be applied to A of Formula 1.

According to an embodiment of the present disclosure, the first polymerization structure, represented by Formula 1, may include a repeating unit represented by the following Formula 2:

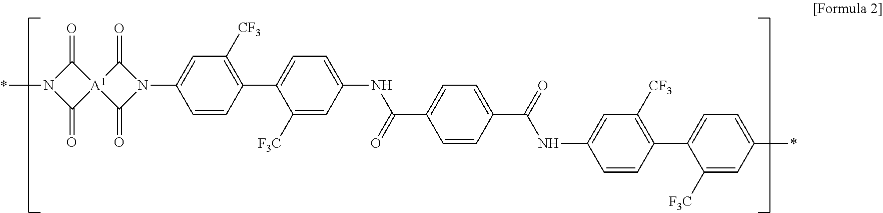

wherein A¹ represents a tetravalent organic group.

The repeating unit represented by Formula 2 corresponds to a structure of *-A-C—B—C—*, represented by Formula 1, in which B is a group derived from terephthaloyl chloride (TPC) and C is a group derived from 2,2′-bis(trifluoromethyl)benzidine (TFDB).

According to an embodiment of the present disclosure, A¹ of Formula 2 may be represented, for example, by at least one of the following Formulas 3 to 12:

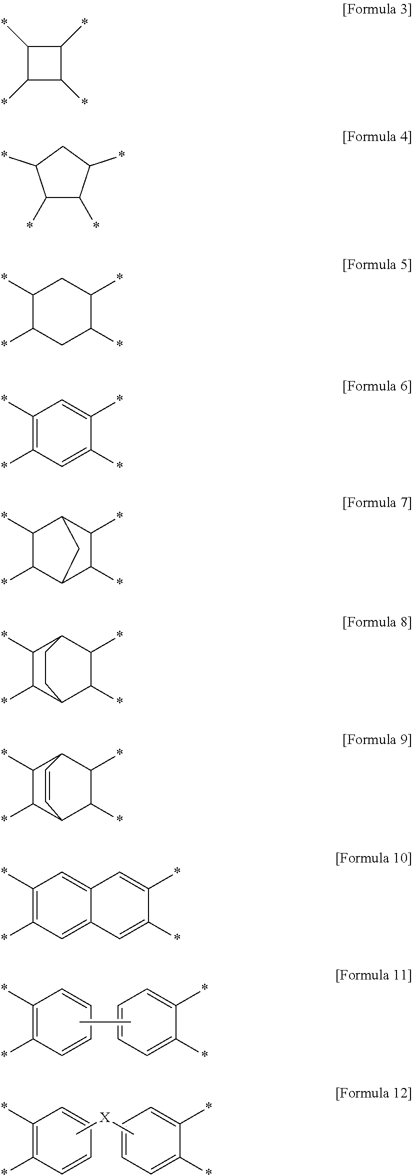

wherein X represents any one of —O—, —S—, —SO₂—, —CO—, —(CH₂)ₙ—, —C(CH₃)₂—, and —C(CF₃)₂—.

According to an embodiment of the present disclosure, the first polymerization structure, represented by Formula 1, may include a repeating unit represented by the following Formula 13:

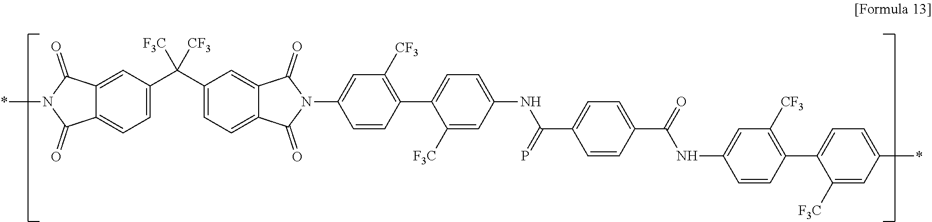

The repeating unit represented by Formula 13 corresponds to a structure of *-A-C—B—C—*, represented by Formula 1, in which A is a group derived from 2,2-bis(3,4-dicarboxyphenyl)hexafluoropropane dianhydride (6FDA), B is a group derived from terephthaloyl chloride (TPC), and C is a group derived from 2,2′-bis(trifluoromethyl)benzidine (TFDB).

In addition, according to an embodiment of the present disclosure, the first polymerization structure represented by Formula 1 may include a repeating unit represented by any one of the following Formulas 14 and 15:

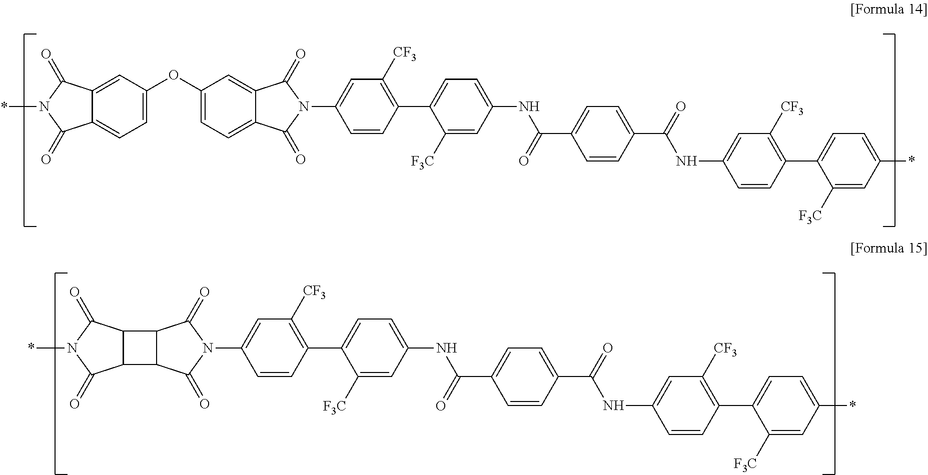

The repeating unit represented by Formula 14 corresponds to a structure of *-A-C—B—C—*, represented by Formula 1, in which A is a group derived from 4,4′-oxydiphthalic anhydride (ODPA), B is a group derived from terephthaloyl chloride (TPC), and C is a group derived from 2,2′-bis(trifluoromethyl)benzidine (TFDB).

The repeating unit represented by Formula 15 corresponds to a structure of *-A-C—B—C—*, represented by Formula 1, in which A is a group derived from cyclobutane-1,2,3,4-tetracarboxylic dianhydride (CBDA), B is a group derived from terephthaloyl chloride (TPC), and C is a group derived from 2,2′-bis(trifluoromethyl)benzidine (TFDB).

In addition, according to an embodiment of the present disclosure, the first polymerization structure represented by Formula 1 may be formed by polymerization of a dianhydride compound and a diamine compound represented by the following Formula 16:

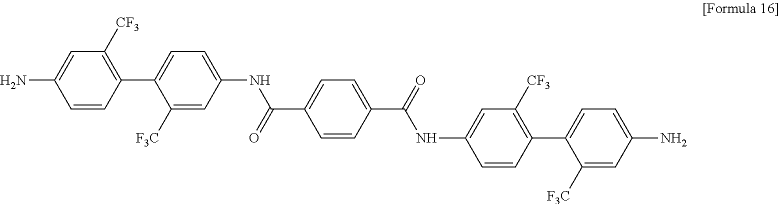 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

The diamine compound represented by Formula 16 is N1,N4-bis(4′-amino-2,2′-bis(trifluoromethyl)-[1,1′-biphenyl]-4-yl) terephthalamide and corresponds to a monomer used to form a polymer having the first polymerization structure, represented by Formula 1. The moiety of —C—B—C— of Formula 1 may be formed by the diamine compound represented by Formula 16.

The diamine compound represented by Formula 16 may be represented by *—C—B—C—*, wherein “B” is a group derived from terephthaloyl chloride (TPC), and “C” is a group derived from 2,2′-bis(trifluoromethyl)benzidine (TFDB).

According to an embodiment of the present disclosure, the diamine compound represented by Formula 16 is used as a monomer for forming a polymer and an optical film.

The diamine compound represented by Formula 16 includes an amide repeating unit. Therefore, according to an embodiment of the present disclosure, a polymer and an optical film having an amide repeating unit can be formed without polymerization of the dicarbonyl compound and the diamine compound for forming the amide repeating unit.

In general, when a dicarbonyl compound and a diamine compound are polymerized in order to form an amide repeating unit, hydrochloric acid (HCl) or chlorine (Cl) is generated. However, according to an embodiment of the present disclosure, little or no hydrochloric acid (HCl) or chlorine (Cl) is generated, since a polymer and an optical film having an amide repeating unit are formed without polymerization of the dicarbonyl compound and the diamine compound for forming the amide repeating unit.

Unlike the present disclosure, when a dicarbonyl compound and a diamine compound are polymerized in order to form an amide repeating unit, an acid is generated as a byproduct, so the pH of the reaction solution or polymer resin may change during or after the reaction, and it may not be easy to adjust the pH of the reaction solution. In addition, when a casting substrate made of a metal, for example, a stainless steel (SUS) substrate, is used in the process of forming an optical film by casting a polymer solution, the acid contained in the polymer solution may cause a problem such as corrosion. Therefore, a cumbersome process of removing the acid, including, for example, precipitation and filtration after polymerization, is required before casting the polymer solution.

In addition, the acid generated in the polymerization process affects the polymerization degree of the polymer, so that the polymerization degree of the polymer may not be uniform. As a result, the polydispersity index (PDI) of the polymer may increase.

On the other hand, when the diamine compound represented by Formula 16 is used according to an embodiment of the present disclosure, a polymer and an optical film having an amide repeating unit can be produced without a process of polymerizing a dicarbonyl compound and a diamine compound for forming an amide repeating unit. Accordingly, problems such as corrosion due to the acid generated during polymerization of the dicarbonyl compound and the diamine compound can be avoided. Therefore, according to an embodiment of the present disclosure, the optical film can be produced without a process for removing an acid, such as precipitation and filtration after polymerization before casting the polymer solution.

In addition, according to an embodiment of the present disclosure, because no acid is generated in the polymerization process for forming an optical film or a polymer, the polymerization degree of the polymer is relatively uniform. According to an embodiment of the present disclosure, the polymer may have a polydispersity index (PDI) of 1.5 to 3.0. According to an embodiment of the present disclosure, the polydispersity index (PDI) may be obtained from the weight average molecular weight (Mw) and the number average molecular weight (Mn) based on polystyrene by gel permeation chromatography (GPC, Waters Alliance, Model: e2695).

The polymerization of the dicarbonyl compound and the diamine compound to form the amide repeating unit is a reaction that proceeds at a very high reaction rate while generating a lot of heat. For example, both the reaction rate and reaction heat between TFDB and TPC at room temperature (25° C.) are much higher than those between TFDB and the dianhydride compound.

For example, when the diamine compound, the dicarbonyl compound, and the dianhydride compound are mixed together and polymerized in order to form the polymer having the first polymerization structure represented by Formula 1, polymerization of the diamine compound and the dicarbonyl compound occurs first, and polymerization of the diamine compound and the dianhydride compound occurs thereafter. Therefore, even if the diamine compound, the dicarbonyl compound, and the dianhydride compound are mixed together and polymerized, a —B—C— repeating unit is formed first, and an -A-C— repeating unit is then formed. As a result, almost no polymer having the first polymerization structure represented by Formula 1 is formed.

Even if the diamine compound, the dicarbonyl compound, and the dianhydride compound are mixed together and polymerized, a copolymer represented by Formula 17, obtained by copolymerization between the -A-C— repeating units and the —B—C— repeating units, is formed, but the polymer having the first polymerization structure represented by Formula 1 is not formed well:

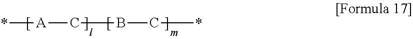

wherein l and m are each an integer of 2 or more.

In addition, even if the diamine compound and the dianhydride compound are polymerized first and the diamine compound and the dicarbonyl compound are then polymerized to form a polyamide-imide copolymer, the copolymer represented by Formula 17 may be formed, but it is difficult to form the polymer having the first polymerization structure represented by Formula 1.

Likewise, even if the diamine compound and the dicarbonyl compound are polymerized first and the diamine compound and the dianhydride compound are then polymerized to form a polyamide-imide copolymer, the copolymer represented by Formula 17 may be formed, but it is difficult to form a polymer having the first polymerization structure represented by Formula 1.

On the other hand, according to an embodiment of the present disclosure, like the first polymerization structure represented by Formula 1, a polymer having regularly and alternately arranged amide repeating units and imide repeating units and an optical film including the polymer can be manufactured.

According to an embodiment of the present disclosure, because the optical film is formed without the polymerization process between the dicarbonyl compound and the diamine compound, no hydrochloric acid (HCl) or chlorine (Cl) is generated during the optical film formation process. Accordingly, the optical film according to an embodiment of the present disclosure has a low chlorine (Cl) concentration.

The optical film according to an embodiment of the present disclosure has a chlorine (Cl) concentration of 100 parts per billion (ppb) by weight or less. According to an embodiment of the present disclosure, ppb is calculated by (weight of chlorine)/(weight of optical film).

According to an embodiment of the present disclosure, “chlorine (Cl)” is intended to include chlorine atoms and chlorine ions (Cl⁻). In addition, according to an embodiment of the present disclosure, chlorine (Cl) may be bonded to other atoms to form molecules, and such chlorine atoms present in molecules are included in the definition of chlorine (Cl) according to an embodiment of the present disclosure.

According to an embodiment of the present disclosure, the optical film is freeze-dried and powdered, chlorine (Cl) is then extracted from the optical film using distilled water to obtain a chlorine (Cl) extract, and ion chromatography analysis is performed on the obtained chlorine (Cl) extract to measure the concentration of chlorine (Cl) in the optical film.

More specifically, according to an embodiment of the present disclosure, a 50 μm-thick optical film was cut into pieces about 0.5 cm×0.5 cm, freeze-dried, powdered, and then extracted through sonication using distilled water for 2 hours to obtain a chlorine (Cl) extract. The chlorine content can be determined by performing ion chromatography analysis on the chlorine extract and calculating the concentration of chlorine. For ion chromatography analysis, two columns [IonPac AS18 Analytical (4×250 mm)+AG18 Guard (4×50 mm)] and an eluent [EGC-KOH III Cartridge from Dionex] may be placed in an ICS-2000 ion chromatography system from Dionex.

The optical film according to an embodiment of the present disclosure may have a chlorine (Cl) concentration of 0.1 to 100 ppb by weight, 0.1 to 50 ppb by weight, or 0.1 to 25 ppb by weight.

It was found that, when chlorine (Cl) atoms remain in the optical film, the likelihood that the light transmittance and mechanical properties of the optical film will change increases. For example, when hydrochloric acid (HCl) is generated in the process of manufacturing the optical film, the acidity of the reaction solution for manufacturing the optical film, for example, the polyamide-amic acid solution may be increased, reactivity during polymerization may be deteriorated, and the polyamic acid and the polyamide-imide polymer may be degraded. In addition, during chemical or thermal imidization in the process of manufacturing the optical film, hydrochloric acid (HCl) reacts with water (H₂O), causing side reactions such as generation of hydronium ions (H₃O⁺) and chlorine ions (Cl⁻). As a result, the optical properties or mechanical properties of the film may be deteriorated.

In addition, when light is irradiated to an optical film containing chlorine (Cl) atoms, degradation or deterioration of the polymer constituting the optical film may be accelerated by photoinitiation of the chlorine (Cl) atoms, etc., or the chemical structure of the polymer resin may be changed. As such, when the chemical structure of the polymer resin constituting the optical film is changed by decomposition or degradation, the light transmittance of the optical film may be lowered, and the flexibility or mechanical strength of the optical film may be deteriorated.

The optical film according to an embodiment of the present disclosure contains little or no chlorine (Cl), and thus can exhibit excellent thermal stability and optical stability. Even if the optical film according to an embodiment of the present disclosure is heat-treated or exposed to light for a long time, the polymer structure in the optical film is not damaged or degraded, and thus excellent optical and mechanical properties of the optical film can be maintained.

Even when exposed to light for a long time, the optical film according to an embodiment of the present disclosure can avoid deterioration in all of light transmittance, flexibility, and strength.

The optical film according to an embodiment of the present disclosure may have light transmittance of 88% or more based on a thickness of 50 μm. In addition, the optical film according to an embodiment of the present disclosure may have light transmittance of 90% or more, or light transmittance of 91% or more, based on a thickness of 50 μm.

The optical film according to an embodiment of the present disclosure may have a yellowness index of 4 or less based on a thickness of 50 μm. In addition, the optical film according to an embodiment of the present disclosure may have a yellowness index of 3.8 or less, or a yellowness index of 3.0 or less, based on a thickness of 50 μm.

The light transmittance and yellowness index may be measured in a wavelength range of 360 to 740 nm using a spectrophotometer in accordance with the ASTM E313 standard. The spectrophotometer used herein may be, for example, CM-3700D manufactured by KONICA MINOLTA.

Another embodiment of the present disclosure provides a polymer having a first polymerization structure represented by the following Formula 1:

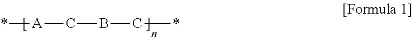

wherein A is a group derived from a dianhydride compound, B is a group derived from a dicarbonyl compound, C is a group derived from a diamine compound, and n represents the number of repetitions of *-A-C—B—C—*, which is the repeating unit, and is an integer of 5 or more.

Hereinafter, an explanation of the above configuration is omitted in order to avoid duplicate description.

According to another embodiment of the present disclosure, n in Formula 1 may be an integer of 10 or more.

In the polymer according to another embodiment of the present disclosure, the content of the first polymerization structure represented by Formula 1 may be 5% by weight or more based on the total weight of the polymer. More specifically, the content of the first polymerized structure represented by Formula 1 may be 10% by weight or more based on the total weight of the polymer.

According to another embodiment of the present disclosure, the dicarbonyl compound is, for example, selected from terephthaloyl chloride (TPC), isophthaloyl chloride (IPC), naphthalene-2,6-dicarbonyl dichloride, naphthalene-2,3-dicarbonyl dichloride, (1,1′-biphenyl)-4,4′-dicarbonyl dichloride, (1,1′-biphenyl)-3,3′-dicarbonyl dichloride, and 4,4′-oxydibenzoylchloride (ODBC).

According to another embodiment of the present disclosure, the diamine compound is, for example, selected from 2,2′-bis(trifluoromethyl)benzidine (TFDB), oxydianiline (ODA), p-phenylenediamine (pPDA), m-phenylenediamine (mPDA), 4,4-methylenedianiline (pMDA), 3,3-methylenedianiline (mMDA), 1,3-bis(3-aminophenoxy)benzene (133APB), 1,3-bis(4-aminophenoxy)benzene (134APB), bisaminophenoxy phenyl hexafluoropropane (4BDAF), 2,2′-bis(3-aminophenyl)hexafluoropropane (33-6F), 2,2′-bis(4-aminophenyl)hexafluoropropane (44-6F), bis(4-aminophenyl)sulfone (4DDS), bis(3-aminophenyl)sulfone (3DDS), 1,3-cyclohexanediamine (13CHD), 1,4-cyclohexanediamine (14CHD), 2,2-bis(4-(4-aminophenoxy)phenyl)propane (6HMDA), 2,2-bis(3-amino-4-hydroxyphenyl)hexafluoropropane (DBOH), bis(4-(4-aminophenoxy)phenyl)sulfone, bis(4-(3-aminophenoxy)phenyl) sulfone, 9,9-bis(4-aminophenyl)fluorene (FDA), and 9,9-bis(4-amino-3-fluorophenyl)fluorene (F-FDA).

According to another embodiment of the present disclosure, the dianhydride compound may include at least one selected from 2,2-bis(3,4-dicarboxyphenyl)hexafluoropropane dianhydride (6FDA), 3,3′,4,4′-biphenyltetracarboxylic dianhydride (BPDA), 4-(2,5-dioxotetrahydrofuran-3-yl)-1,2,3,4-tetrahydronaphthalene-1,2-dicarboxylic anhydride (TDA), pyromellitic dianhydride (PMDA), benzophenone tetracarboxylic dianhydride (BTDA), 4,4′-oxydiphthalic anhydride (ODPA), 4,4′-bis(3,4-dicarboxyphenoxy)-diphenyl sulfide dianhydride (BDSDA), 3,3′,4,4′-diphenylsulfonetetracarboxylic dianhydride (SO₂DPA), 4,4′-(4,4′-isopropylidenediphenoxy)bis(phthalic anhydride) (6HBDA), cyclobutane-1,2,3,4-tetracarboxylic dianhydride (CBDA), 1,2,3,4-cyclopentane-tetracarboxylic dianhydride (CPDA), 1,2,4,5-cyclohexane-tetracarboxylic dianhydride (CHDA), and dicyclohexyl-3,4,3′,4′-tetracarboxylic dianhydride (HBPDA).

According to another embodiment of the present disclosure, A of Formula 1 may be derived from one dianhydride compound or two or more dianhydride compounds. A of Formula 1 may be formed from one dianhydride compound, or from two or more different dianhydride compounds.

The first polymerization structure according to another embodiment of the present disclosure may include a repeating unit represented by the following Formula 2:

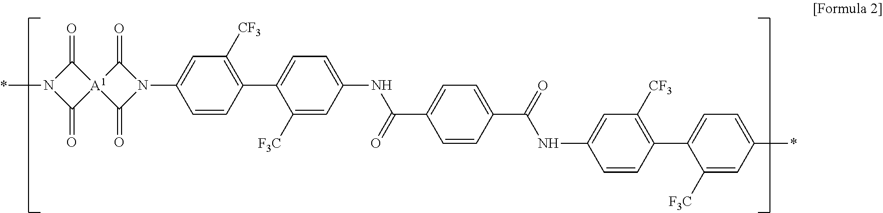

wherein A¹ represents a tetravalent organic group.

According to another embodiment of the present disclosure, A¹ may be represented by at least one of the following Formulas 3 to 12:

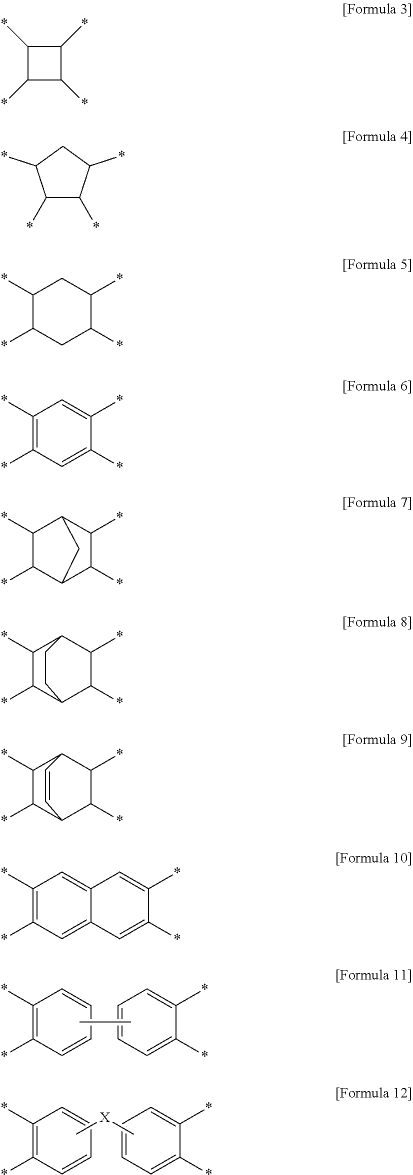

wherein X represents any one of —O—, —S—, —SO₂—, —CO—, —(CH₂)ₙ—, —C(CH₃)₂—, and —C(CF₃)₂—.

In another embodiment of the present disclosure, the first polymerization structure may include a repeating unit represented by any one of the following Formulas 13, 14, and 15:

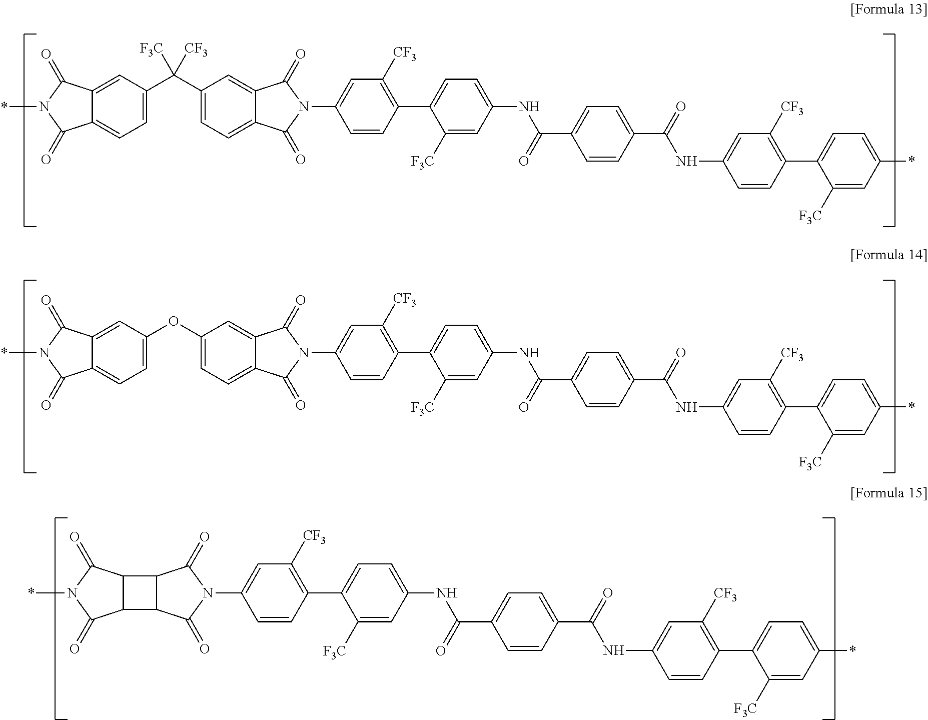

In another embodiment of the present disclosure, the first polymerization structure may be formed by polymerization of a dianhydride compound and a diamine compound represented by the following Formula 16:

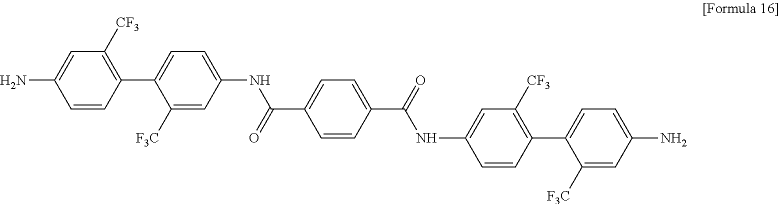 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

The dianhydride compound and the diamine compound represented by Formula 16 may be used as monomers for the preparation of the polymer according to another embodiment of the present disclosure. The polymer according to another embodiment of the present disclosure may be formed by polymerization of the dianhydride compound and the diamine compound represented by Formula 16.

The polymer according to another embodiment of the present disclosure may have a polydispersity index (PDI) of 1.5 to 3.0.

Another embodiment of the present disclosure provides a polymer resin including the polymer described above.

According to another embodiment of the present disclosure, the polymer resin may be prepared without polymerizing the dicarbonyl compound and the diamine compound. Therefore, hydrochloric acid (HCl) or chlorine (Cl) may not be generated during the process of manufacturing the polymer resin according to another embodiment of the present disclosure. Therefore, the polymer resin according to another embodiment of the present disclosure has a low chlorine (Cl) concentration.

The polymer resin according to another embodiment of the present disclosure may contain 100 ppb (parts per billion) by weight or less of chlorine (Cl).

The polymer resin according to another embodiment of the present disclosure may have a chlorine (Cl) concentration of 0.1 to 100 ppb, 0.1 to 50 ppb, or 0.1 to 25 ppb by weight.

Another embodiment of the present disclosure provides a polyamide-imide precursor formed by the diamine compound represented by Formula 16 and a dianhydride compound.

According to another embodiment of the present disclosure, the precursor may refer to a compound in the stage before the polymer is formed. The polyamide-imide precursor according to another embodiment of the present disclosure may be a polyamide-imide compound including a carbonyl group and a carboxylic group in the compound structure. On the other hand, the polymer may be a polyamide-imide compound including an imide ring formed by imidization.

More specifically, another embodiment of the present disclosure provides a polyamide-imide precursor including a repeating unit represented by the following Formula 18:

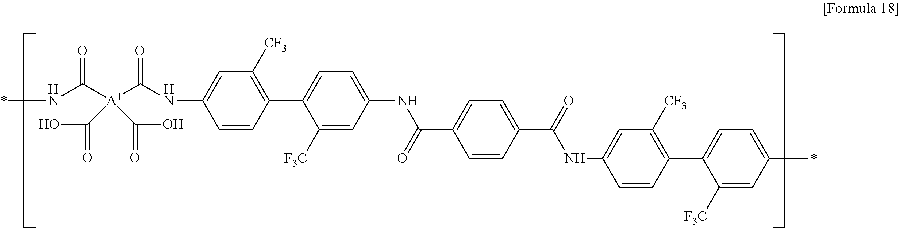

wherein A¹ represents a tetravalent organic group. A¹ is as described above. A¹ may be represented by at least one of Formulas 3 to 12 described above.

According to another embodiment of the present disclosure, the polyamide-imide precursor may include a repeating unit represented by any one of the following Formulas 19, 20 and 21:

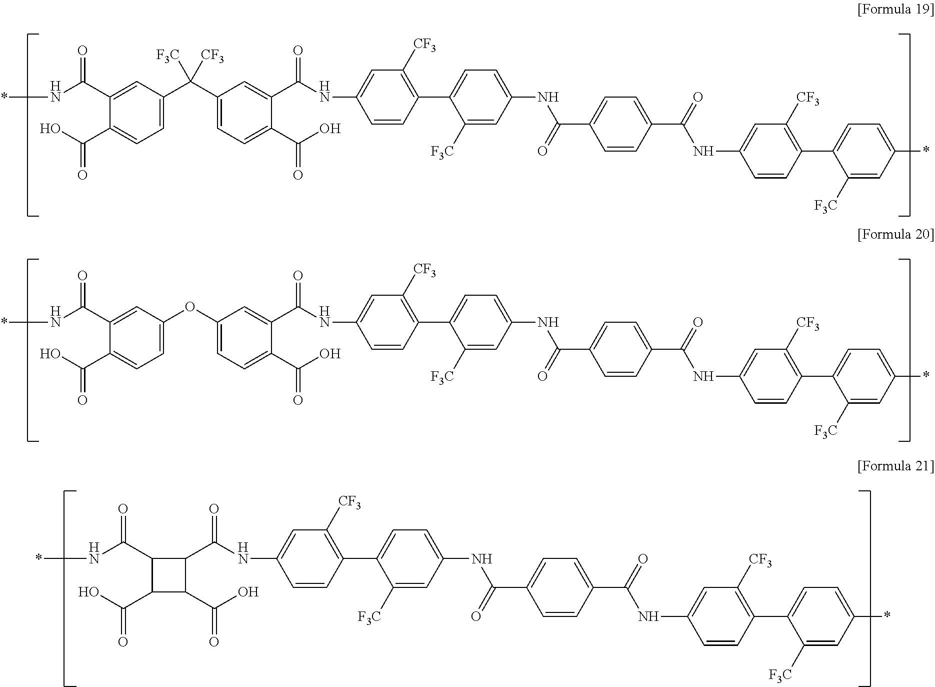

Another embodiment of the present disclosure provides a display device including the optical film described above.

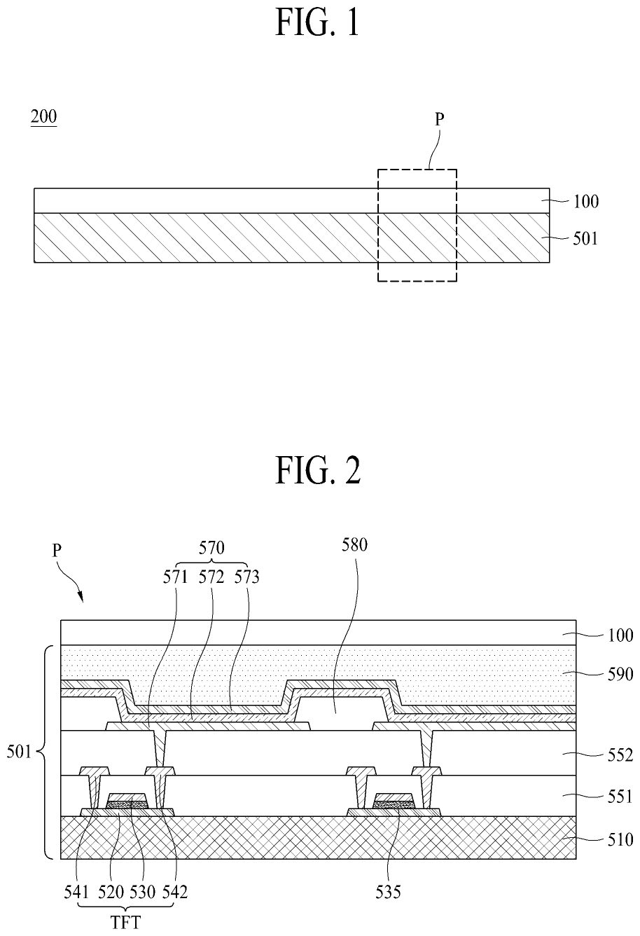

Hereinafter, the display device including the optical film according to another embodiment of the present disclosure will be described with reference to FIGS. 1 and 2.

FIG. 1 is a cross-sectional view illustrating a part of a display device 200 according to another embodiment, and FIG. 2 is an enlarged cross-sectional view of part “P” in FIG. 1.

Referring to FIG. 1, the display device 200 according to another embodiment of the present disclosure includes a display panel 501 and an optical film 100 on the display panel 501.

Referring to FIGS. 1 and 2, the display panel 501 includes a substrate 510, a thin film transistor TFT on the substrate 510, and an organic light-emitting device 570 connected to the thin film transistor TFT. The organic light-emitting device 570 includes a first electrode 571, an organic light-emitting layer 572 on the first electrode 571, and a second electrode 573 on the organic light-emitting layer 572. The display device 200 shown in FIGS. 1 and 2 is an organic light-emitting display device.

The substrate 510 may be formed of glass or plastic. Specifically, the substrate 510 may be formed of plastic such as a polyimide-based resin. Although not shown, a buffer layer may be disposed on the substrate 510.

The thin film transistor TFT is disposed on the substrate 510. The thin film transistor TFT includes a semiconductor layer 520, a gate electrode 530 that is insulated from the semiconductor layer 520 and at least partially overlaps the semiconductor layer 520, a source electrode 541 connected to the semiconductor layer 520, and a drain electrode 542 that is spaced apart from the source electrode 541 and is connected to the semiconductor layer 520.

Referring to FIG. 2, a gate insulating layer 535 is disposed between the gate electrode 530 and the semiconductor layer 520. An interlayer insulating layer 551 may be disposed on the gate electrode 530, and a source electrode 541 and a drain electrode 542 may be disposed on the interlayer insulating layer 551.

A planarization layer 552 is disposed on the thin film transistor TFT to planarize the top of the thin film transistor TFT.

A first electrode 571 is disposed on the planarization layer 552. The first electrode 571 is connected to the thin film transistor TFT through a contact hole provide d in the planarization layer 552.

A bank layer 580 is disposed on the planarization layer 552 in a part of the first electrode 571 to define pixel areas or light-emitting areas. For example, the bank layer 580 is disposed in the form of a matrix at the boundaries between a plurality of pixels to define the respective pixel regions.

The organic light-emitting layer 572 is disposed on the first electrode 571. The organic light-emitting layer 572 may also be disposed on the bank layer 580. The organic light-emitting layer 572 may include one light-emitting layer, or two or more light-emitting layers stacked in a vertical direction. Light having any one color among red, green, and blue may be emitted from the organic light-emitting layer 572, and white light may be emitted therefrom.

The second electrode 573 is disposed on the organic light-emitting layer 572.

The first electrode 571, the organic light-emitting layer 572, and the second electrode 573 may be stacked to constitute the organic light-emitting device 570.

Although not shown, when the organic light-emitting layer 572 emits white light, each pixel may include a color filter for filtering the white light emitted from the organic light-emitting layer 572 based on a particular wavelength. The color filter is formed in the light path.

A thin-film encapsulation layer 590 may be disposed on the second electrode 573. The thin-film encapsulation layer 590 may include at least one organic layer and at least one inorganic layer, and the at least one organic layer and the at least one inorganic layer may be alternately disposed.

The optical film 100 is disposed on the display panel 501 having the stack structure described above.

Hereinafter, a method of manufacturing an optical film according to an embodiment of the present disclosure will be described.

Hereinafter, the present disclosure will be described in more detail with reference to specific Examples and Comparative Examples. However, the Examples and Comparative Examples should not be construed as limiting the scope of the present disclosure.

### <Preparation Example 1> Preparation of Precursor

355.87 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 46.235 g (0.06 mol) of N1,N4-bis(4′-amino-2,2′-bis(trifluoromethyl)-[1,1′-biphenyl]-4-yl) terephthalamide (BIBS, FNG Research, Cheongju, Chungbuk, South Korea), which is a diamine compound represented by Formula 16 below, was dissolved therein, and the resulting solution was maintained at 25° C. 26.655 g (0.06 mol) of 2,2-bis(3,4-dicarboxyphenyl)hexafluoropropane dianhydride (6F DA) was added thereto, thoroughly dissolved therein, and allowed to react for 24 hours to obtain a polymer solution having a solid concentration of 17% by weight. As a result, a polymer solution containing a polyamide-imide precursor was prepared.

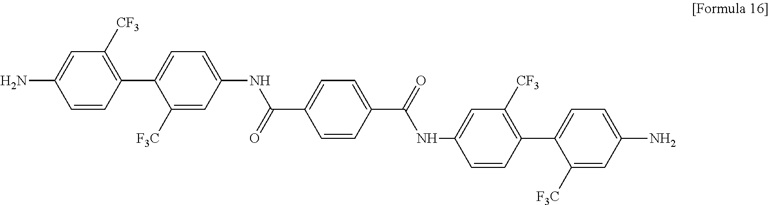 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

The polyamide-imide precursor prepared in Preparation Example 1 may include a repeating unit represented by the following Formula 19:

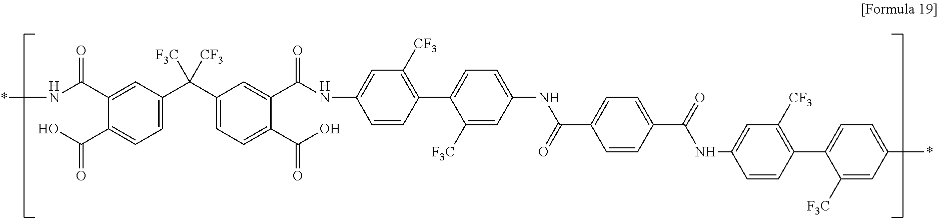

### <Preparation Example 2> Preparation of Polymer

10.44 g of pyridine and 13.48 g of acetic anhydride were added to the polymer solution prepared in Preparation Example 1, stirred for 30 minutes, stirred at 80° C. for 30 minutes, and then cooled to room temperature to prepare a polymer solution containing a polyamide-imide polymer.

The polyamide-imide polymer prepared in Preparation Example 2 includes the repeating unit represented by Formula 13. The number (n) of repetitions of the repeating unit may be 5 or more, and may be 10 or more.

### <Preparation Example 3> Preparation of Polymer Resin

3,000 mL of methanol was added to the resulting polymer solution prepared in Preparation Example 2 to form a precipitate. The precipitated solid was filtered to obtain a polymer resin as a white solid. The obtained polymer resin was a solid powder. The polymer resin prepared in Preparation Example 3 was a polyamide-imide polymer resin.

### <Preparation Example 4> Preparation of Precursor

316.608 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 46.235 g (0.06 mol) of the diamine compound represented by Formula 16 was dissolved therein, and the resulting solution was maintained at 25° C. 18.613 g (0.06 mol) of 4,4′-oxydiphthalic anhydride (ODPA) was added thereto, thoroughly dissolved, and allowed to react for 24 hours to obtain a polymer solution having a solid concentration of 17% by weight. As a result, a polymer solution containing a polyamide-imide precursor was prepared.

The polyamide-imide precursor prepared in Preparation Example 4 may include a repeating unit represented by the following Formula 20:

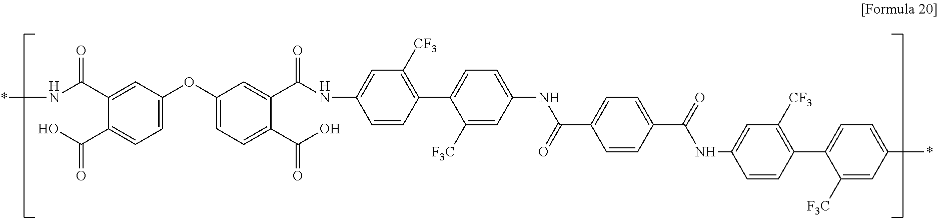

### <Preparation Example 5> Preparation of Polymer

10.44 g of pyridine and 13.48 g of acetic anhydride were added to the polymer solution prepared in Preparation Example 4, stirred for 30 minutes, stirred at 80° C. for 30 minutes, and then cooled to room temperature to prepare a polymer solution containing a polyamide-imide polymer.

The polyamide-imide polymer prepared in Preparation Example 5 includes the repeating unit represented by Formula 14. The number (n) of repetitions of the repeating unit may be 5 or more, and may be 10 or more.

### <Preparation Example 6> Preparation of Polymer Resin

3,000 mL of methanol was added to the polymer solution prepared in Preparation Example 5 to form a precipitate. The precipitate was filtered to obtain a polymer resin as a white solid. The obtained polymer resin was a solid powder. The polymer resin prepared in Preparation Example 6 was a polyamide-imide polymer resin.

### <Preparation Example 7> Preparation of Precursor

293.229 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 23.117 g (0.03 mol) of the diamine compound represented by Formula 16 was dissolved therein, and the resulting solution was maintained at 25° C. 5.883 g (0.03 mol) of cyclobutane-1,2,3,4-tetracarboxylic dianhydride (CB DA) was added thereto, thoroughly dissolved, and allowed to react for 24 hours to obtain a polymer solution having a solid concentration of 9% by weight. As a result, a polymer solution containing a polyamide-imide precursor was prepared.

The polyamide-imide precursor prepared in Preparation Example 7 includes a repeating unit represented by the following Formula 21:

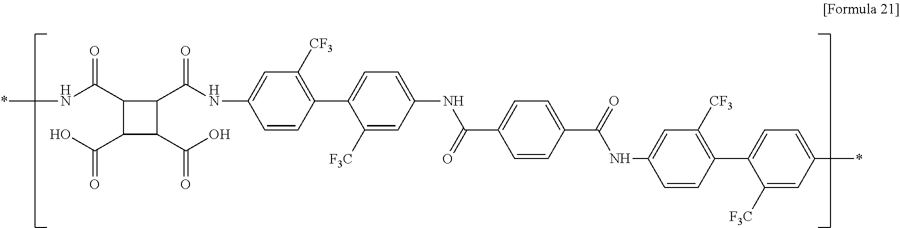

### <Preparation Example 8> Preparation of Polymer

5.22 g of pyridine and 6.74 g of acetic anhydride were added to the polymer solution prepared in Preparation Example 7, stirred for 30 minutes, stirred at 80° C. for 30 minutes, and then cooled to room temperature to prepare a polymer solution containing a polyamide-imide polymer.

The polyamide-imide polymer prepared in Preparation Example 8 includes the repeating unit represented by Formula 15. The number (n) of repetitions of the repeating unit may be 5 or more, and may be 10 or more.

### <Preparation Example 9> Preparation of Polymer Resin

3,000 mL of methanol was added to the polymer solution prepared in Preparation Example 8 to form a precipitate. The precipitate was filtered to obtain a polymer resin as a white solid. The obtained polymer resin was a solid powder. The polymer resin prepared in Preparation Example 9 was a polyamide-imide polymer resin.

### Example 1

The polymer solution prepared in Preparation Example 2 was cast on a substrate. The substrate used herein may be a glass substrate, an aluminum substrate, a stainless steel (SUS) belt, or a heat-resistant polymer film substrate. In this example, the polymer solution prepared in Preparation Example 2 was applied onto a glass substrate, cast, and dried with hot air at 120° C. for 30 minutes to produce an intermediate film. According to an embodiment of the present disclosure, the film before heat treatment is referred to as an “intermediate film”.

The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was cooled slowly and the film was separated from the frame. The separated film was heat-treated again at 250° C. for 5 minutes. As a result, the optical film according to Example 1 was produced. The optical film produced in Example 1 was a polyamide-imide-based film.

### Example 2

The polymer resin prepared as the solid powder in Preparation Example 3 was dissolved in dimethylacetamide (DMAc) at a concentration of 17 wt % to prepare a polymer resin solution.

The prepared polymer resin solution was applied to a glass substrate, cast, and dried with hot air at 120° C. for 30 minutes to produce an intermediate film. The intermediate film refers to a film before heat treatment.

The produced film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Example 2 was produced. The optical film produced in Example 2 was a polyamide-imide-based film.

### Example 3

The polymer solution prepared in Preparation Example was cast on a substrate. In this example, the polymer solution prepared in Preparation Example 5 was applied to a glass substrate, cast, and dried with hot air at 120° C. for 30 minutes to produce an intermediate film. According to an embodiment of the present disclosure, the film before heat treatment is referred to as an “intermediate film”.

The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was cooled slowly and the film was separated from the frame. The separated film was heat-treated again at 250° C. for 5 minutes. As a result, the optical film according to Example 3 was produced. The optical film produced in Example 3 was a polyamide-imide-based film.

### Example 4

The polymer resin prepared as the solid powder in Preparation Example 6 was dissolved in dimethylacetamide (DMAc) at a concentration of 17 wt % to prepare a polymer resin solution.

The prepared polymer resin solution was applied to a glass substrate, cast, and dried with hot air at 120° C. for minutes to produce an intermediate film. The intermediate film refers to a film before heat treatment.

The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Example 4 was produced. The optical film produced in Example 4 was a polyamide-imide-based film.

### Example 5

The polymer solution prepared in Preparation Example 8 was cast on a substrate. In this example, the polymer solution prepared in Preparation Example 8 was applied to a glass substrate, cast, and dried with hot air at 120° C. for minutes to produce an intermediate film. According to an embodiment of the present disclosure, the film before heat treatment is referred to as an “intermediate film”.

The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was cooled slowly and the film was separated from the frame. The separated film was heat-treated again at 250° C. for 5 minutes. As a result, the optical film according to Example 5 was produced. The optical film produced in Example 5 was a polyamide-imide-based film.

### Example 6

The polymer resin prepared as the solid powder in Preparation Example 9 was dissolved in dimethylacetamide (DMAc) at a concentration of 9 wt % to prepare a polymer resin solution.

The prepared polymer resin solution was applied to a glass substrate, cast and dried with hot air at 120° C. for 30 minutes to produce an intermediate film. The intermediate film refers to the film before heat treatment.

The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Example 6 was produced. The optical film produced in Example 6 was a polyamide-imide-based film.

### Comparative Example 1

344.715 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 25.618 g (0.08 mol) of TFDB was dissolved therein, and the resulting solution was maintained at 25° C. 17.770 g (0.04 mol) of 6FDA was added thereto, thoroughly dissolved, and allowed to react for 1 hour. Then, the temperature of the reactor was dropped to 10° C., 8.121 g (0.04 mol) of TPC was added thereto, and the resulting solution was allowed to react at 25° C. for 12 hours to obtain a polymer solution having a solid concentration of 13% by weight.

6.96 g of pyridine and 8.99 g of acetic anhydride were added to the obtained polymer solution, stirred for 30 minutes, stirred at 80° C. for 30 minutes, and then cooled to room temperature to prepare a polyamide-imide polymer solution.

The prepared polymer solution was applied to a glass substrate, cast, and dried with hot air at 120° C. for 30 minutes to produce an intermediate film. The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Comparative Example 1 was produced. The optical film produced in Comparative Example 1 was a polyamide-imide-based film.

### Comparative Example 2

347.863 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 32.023 g (0.1 mol) of TFDB was dissolved therein, and the resulting solution was maintained at 25° C. 9.806 g (0.05 mol) of ODPA was added thereto, thoroughly dissolved, and allowed to react for 24 hours. Then, the temperature of the reactor was dropped to 10° C., 10.151 g (0.05 mol) of TPC was added thereto, and the resulting solution was allowed to react at 25° C. for 12 hours to obtain a polymer solution having a solid concentration of 13% by weight.

8.70 g of pyridine and 11.23 g of acetic anhydride were added to the obtained polymer solution, stirred for 30 minutes, stirred at 80° C. for 30 minutes, and then cooled to room temperature to prepare a polyamide-imide polymer solution.

The prepared polymer resin solution was applied to a glass substrate, cast, and dried with hot air at 120° C. for minutes to produce an intermediate film. The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Comparative Example 2 was produced. The optical film produced in Comparative Example 2 was a polyamide-imide-based film.

### Comparative Example 3

367.899 g of N,N-dimethylacetamide (DMAc) was charged in a 1 L reactor equipped with a stirrer, a nitrogen injector, a dropping funnel, a temperature controller, and a cooler while nitrogen was passed through the reactor. Then, the temperature of the reactor was adjusted to 25° C., 22.416 g (0.07 mol) of TFDB was dissolved therein, and the resulting solution was maintained at 25° C. 6.864 g (0.035 mol) of CBDA was added thereto, thoroughly dissolved therein, and allowed to react for 24 hours. Then, the temperature of the reactor was dropped to 10° C., 7.106 g (0.035 mol) of TPC was added thereto, and the resulting solution was allowed to react at 25° C. for 12 hours to obtain a polymer solution having a solid concentration of 9% by weight.

6.90 g of pyridine and 7.86 g of acetic anhydride were added to the obtained polymer solution, stirred for 30 minutes, stirred at 80° C. for 30 minutes, and then cooled to room temperature to prepare a polyamide-imide polymer solution.

The prepared polymer resin solution was applied to a glass substrate, cast, and dried with hot air at 120° C. for 30 minutes to produce an intermediate film. The produced intermediate film was peeled off from the glass substrate and fixed to a frame with a pin.

The frame to which the intermediate film was fixed was placed in a vacuum oven, the temperature was elevated from 100° C. to 280° C. at a temperature elevation rate of 3° C./min, and then the film was heat-treated at the constant temperature of 280° C. for 20 minutes. After the heat treatment, the oven was slowly cooled and the film was separated from the frame. The separated film was heat-treated again at 250° C. for 5 minutes. As a result, the optical film according to Comparative Example 3 was produced. The optical film produced in Comparative Example 3 was a polyamide-imide film.

<Measurement of Physical Properties>

The physical properties of optical films produced in Examples 1 to 6 and Comparative Examples 1 to 3 were measured.
(1) Light transmittance (TT) (%): the average optical transmittance at a wavelength of 360 to 740 nm was measured using a spectrophotometer (CM-3700D, KONICA MINOLTA) in accordance with the ASTM E313 standard. The light transmittance was measured for an optical film having a thickness of 50 μm.
(2) Yellowness index (Y.I.): the yellowness index was measured using a spectrophotometer (CM-3700D, KONICA MINOLTA) in accordance with the ASTM E313 standard. The yellowness index was measured for an optical film having a thickness of 50 μm.
(3) Polydispersity index (PDI)

The weight average molecular weight (Mw) and the number average molecular weight (Mn) of the polymer, converted based on polystyrene, were measured using gel permeation chromatography (GPC, Waters Alliance, Model: e2695).

The polymer to be measured was dissolved at a concentration of 1% in tetrahydrofuran and was injected in an amount of 20 μl into GPC. The mobile phase of GPC was tetrahydrofuran, and was fed at a flow rate of 1.0 mL/min, and analysis was conducted at 30° C. Two columns from Waters Styragel HR3 were connected in series. The detector used herein was an RI detector (Waters Alliance, 2414) and measurement was conducted at 40° C. At this time, the polydispersity index (PDI) was calculated by dividing the measured weight average molecular weight (Mw) by the number average molecular weight (Mn).
(4) Chlorine (Cl) content

The content of chlorine (Cl) was expressed as the concentration (ppb, part per billion) of chlorine.

A 50 μm-thick optical film was cut into pieces about 0.5 cm×0.5 cm, freeze-dried, powdered, and then extracted through sonication using distilled water for 2 hours to obtain a chlorine (Cl) extract. The chlorine content was measured by performing ion chromatography analysis on the chlorine extract and calculating the concentration of chlorine. For ion chromatography analysis, two columns [IonPac AS18 Analytical (4×250 mm)+AG18 Guard (4×50 mm)] and an eluent [EGC-KOH III Cartridge from Dionex] were placed in an ICS-2000 ion chromatography system from Dionex.

Specifically, the content of chlorine (Cl) was measured using the following process.

Measurement apparatus: Ion chromatography analysis was performed using two columns [IonPac AS18 Analytical (4×250 mm)+AG18 Guard (4×50 mm)] and an eluent [EGC-KOH III Cartridge from Dionex] in an ICS-2000 ion chromatography system from Dionex.

Measurement method: each of the 50 μm-thick optical films manufactured in Examples 1 to 5 and Comparative Examples 1 to 3 was cut to a size of about 0.5 cm×0.5 cm, followed by freeze-drying and pulverizing, to prepare an optical film powder. Then, the optical film powder was mixed with distilled water at a concentration of 5 wt %, and then chlorine (Cl), particularly chlorine ions (Cl⁻), were extracted from the optical film. Specifically, 0.2 g of the optical film powder and 3.8 g of water were charged in a 20 mL vial, and sonication extraction was performed for 2 hours using a 5510 ultrasonic bath produced by Branson Ultrasonics. As a result, a chlorine extraction mixture containing chlorine (Cl) extracted from the optical film was prepared. The prepared chlorine extraction mixture was filtered through a 0.45 μm nylon filter to prepare a sample for measurement. 20 μL of the sample for measurement was injected into an ion chromatograph device set at a column temperature of 30° C. and a measurement cell temperature of 35° C., and then the area of the peak corresponding to the chlorine ions, among the separated ion peaks, was determined. In order to calculate the chlorine ion content, Dionex Seven Anion Standard from Thermo Scientific was diluted with distilled water to prepare standard chlorine ion solutions in a concentration range of 0.04 ppm to 1 ppm (0.04 ppm, 0.06 ppm, 0.08 ppm, 0.1 ppm, and 1.0 ppm), and ion chromatography analysis was performed on the standard chlorine ion solutions in the same manner as for the sample for measurement. A calibration curve was drawn by determining the area of the peak corresponding to the chlorine ion measured using the standard solution.

The calibration curve is expressed as a primary function in the following Equation 1:

y=ax+b [Equation 1]

wherein y is the peak area, x is the concentration of the standard solution, a is the slope of the calibration curve, and b is the y-axis intercept of the calibration curve. By applying the calibration curve obtained in Equation 1 to the peak area (y) of the sample for measurement, the chlorine concentration (x) of the s ample for measurement can be calculated. The chlorine concentration (x) of the sample for measurement can be obtained using the following Equation 2.

x=(y−b)/a [Equation 2]

Next, the content of chlorine in the optical film is calculated in consideration of the dilution ratio applied to preparation of the sample for measurement. The distilled water used to prepare the sample for measurement does not contain chlorine (Cl). It is considered that chlorine (Cl) is derived from the optical film powder and that the concentration of chlorine in the sample for measurement is diluted with distilled water. Therefore, conversion is required in order to calculate the concentration of chlorine in the optical film. Specifically, the weight ratio of the optical film applied to the sample for measurement may be calculated using the following Equation 3:

Weight ratio of optical film in sample for measurement=(weight of optical film)/(weight of optical film+weight of distilled water) [Equation 3]
wherein the weight of optical film is the weight of the optical film used to produce the sample for measurement.

Next, the chlorine concentration of the optical film is calculated in accordance with the following Equation 4 using the weight ratio of the optical film with respect to the sample for measurement and the concentration of chlorine in the sample for measurement.

Chlorine concentration of optical film=(chlorine concentration in sample for measurement)/(weight ratio of optical film to sample for measurement) [Equation 4]

The measurement results are shown in Table 1 below.

TABLE 1

| | Thickness | Light | | Polydispersity | Chlorine | |
|---|---|---|---|---|---|---|
| Item | (μm) | transmittance (%) | Y.I. | index | concentration | |
| Example 1 | 50 | 90.51 | 1.69 | 2.21 | 18 | ppb |
| Example 2 | 50 | 90.72 | 1.33 | 2.17 | 15 | ppb |
| Example 3 | 50 | 89.40 | 3.58 | 2.41 | 22 | ppb |
| Example 4 | 50 | 89.48 | 2.95 | 2.14 | 14 | ppb |
| Example 5 | 50 | 89.10 | 3.71 | 2.44 | 20 | ppb |
| Example 6 | 50 | 89.21 | 3.60 | 2.22 | 18 | ppb |
| Comparative | 50 | 90.10 | 1.91 | 2.78 | 794 | ppm |
| Example 1 | | | | | | |
| Comparative | 50 | 89.32 | 3.87 | 2.59 | 882 | ppm |
| Example 2 | | | | | | |
| Comparative | 51 | 88.57 | 12.2 | 2.62 | 933 | ppm |
| Example 3 | | | | | | |

As can be seen from the results of Table 1, the optical film according to an embodiment of the present disclosure has a low yellowness index, excellent light transmittance, a low polydispersity index (PDI), and low chlorine (Cl) content.

### EXPLANATION OF REFERENCE NUMERALS

100: Optical film
200: Display device
501: Display panel

1. An optical film comprising a polymer having a first polymerization structure represented by the following Formula 1: 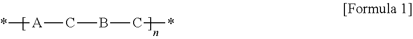
wherein A is a group derived from a dianhydride compound;
B is a group derived from a dicarbonyl compound;
C is a group derived from a diamine compound; and
n represents a number of repetitions of *-A-C—B—C—*, which is a repeating unit, and is an integer of 5 or more.

2. The optical film according to claim 1, wherein n is an integer of 10 or more.

3. The optical film according to claim 1, wherein a content of the first polymerization structure is 5% by weight or more based on the total weight of the optical film.

4. The optical film according to claim 1, wherein a content of the first polymerization structure is 10% by weight or more based on the total weight of the optical film.

5. The optical film according to claim 1, wherein the dicarbonyl compound comprises at least one selected from terephthaloyl dichloride (TPC), isophthaloyl chloride (IPC), naphthalene-2,6-dicarbonyl dichloride, naphthalene-2,3-dicarbonyl dichloride, 1,1′-biphenyl-4,4′-dicarbonyl dichloride, 1,1′-biphenyl-3,3′-dicarbonyl dichloride, and 4,4′-oxydibenzoylchloride (ODBC).

6. The optical film according to claim 1, wherein the diamine compound comprises at least one selected from 2,2′-bis(trifluoromethyl)benzidine (TFDB), oxydianiline (ODA), p-phenylenediamine (pPDA), m-phenylenediamine (mPDA), 4,4-methylenedianiline (pMDA), 3,3-methylenedianiline (mMDA), 1,3-bis(3-aminophenoxy)benzene (133APB), 1,3-bis(4-aminophenoxy)benzene (134APB), bisaminophenoxy phenyl hexafluoropropane (4BDAF), 2,2′-bis(3-aminophenyl) hexafluoropropane (33-6F), 2,2′-bis(4-aminophenyl) hexafluoropropane (44-6F), bis(4-aminophenyl)sulfone (4DDS), bis(3-aminophenyl)sulfone (3DDS), 1,3-cyclohexanediamine (13CHD), 1,4-cyclohexanediamine (14CHD), 2,2-bis(4-(4-aminophenoxy)phenyl)propane (6HMDA), 2,2-bis(3-amino-4-hydroxyphenyl)hexafluoropropane (DBOH), bis(4-(4-aminophenoxy)phenyl)sulfone, bis(4-(3-aminophenoxy)phenyl)sulfone, 9,9-bis(4-aminophenyl)fluorene (FDA), and 9,9-bis(4-amino-3-fluorophenyl)fluorene (F-FDA).

7. The optical film according to claim 1, wherein the dianhydride compound comprises at least one selected from 2,2-bis(3,4-dicarboxyphenyl)hexafluoropropane dianhydride (6FDA), 3,3′,4,4′-biphenyltetracarboxylic dianhydride (BPDA), 4-(2,5-dioxotetrahydrofuran-3-yl)-1,2,3,4-tetrahydronaphthalene-1,2-dicarboxylic anhydride (TDA), pyromellitic dianhydride (PMDA), benzophenone tetracarboxylic dianhydride (BTDA), 4,4′-oxydiphthalic anhydride (ODPA), 4,4′-bis(3,4-dicarboxyphenoxy)-diphenyl sulfide dianhydride (BDSDA), 3,3′,4,4′-diphenylsulfonetetracarboxylic dianhydride (SO₂DPA), 4,4′-(4,4′-isopropylidenediphenoxy)bis(phthalic anhydride) (6HBDA), cyclobutane-1,2,3,4-tetracarboxylic dianhydride (CBDA), 1,2,3,4-cyclopentane-tetracarboxylic dianhydride (CPDA), 1,2,4,5-cyclohexane-tetracarboxylic dianhydride (CHDA), and dicyclohexyl-3,4,3′,4′-tetracarboxylic dianhydride (HBPDA).

8. The optical film according to claim 1, wherein the first polymerization structure comprises a repeating unit represented by the following Formula 2: 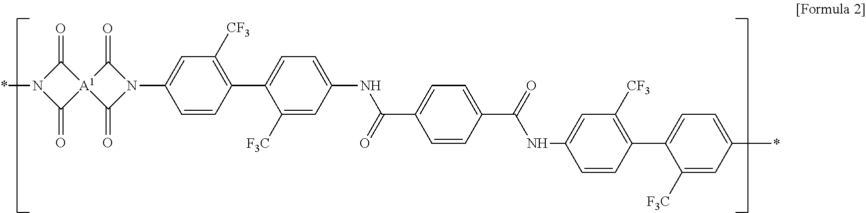
wherein A¹ represents a tetravalent organic group.

9. The optical film according to claim 8, wherein A¹ is represented by at least one of the following Formulas 3 to 12: 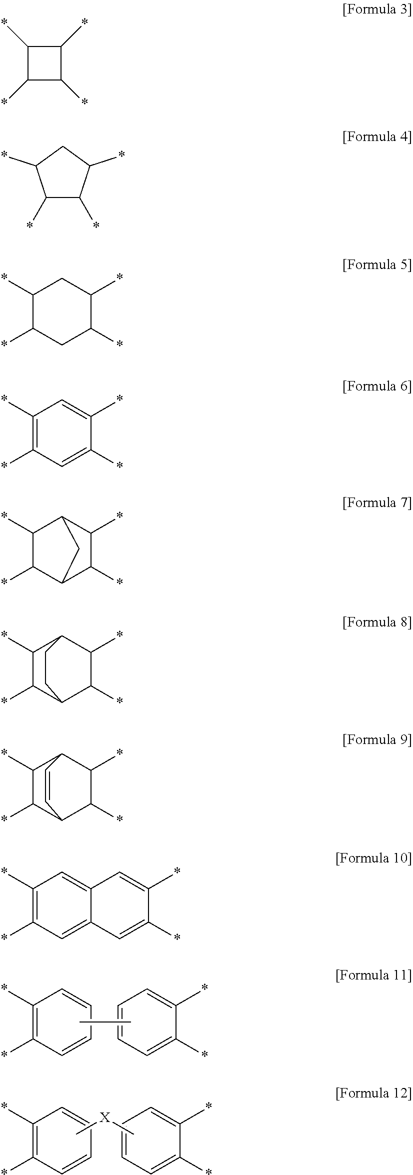
wherein X represents any one of —O—, —S—, —SO₂—, —CO—, —(CH₂)—, —C(CH₃)₂—, and —C(CF₃)₂—.

10. The optical film according to claim 1, wherein the first polymerization structure comprises a repeating unit represented by any one of the following Formulas 13, 14, and 15:

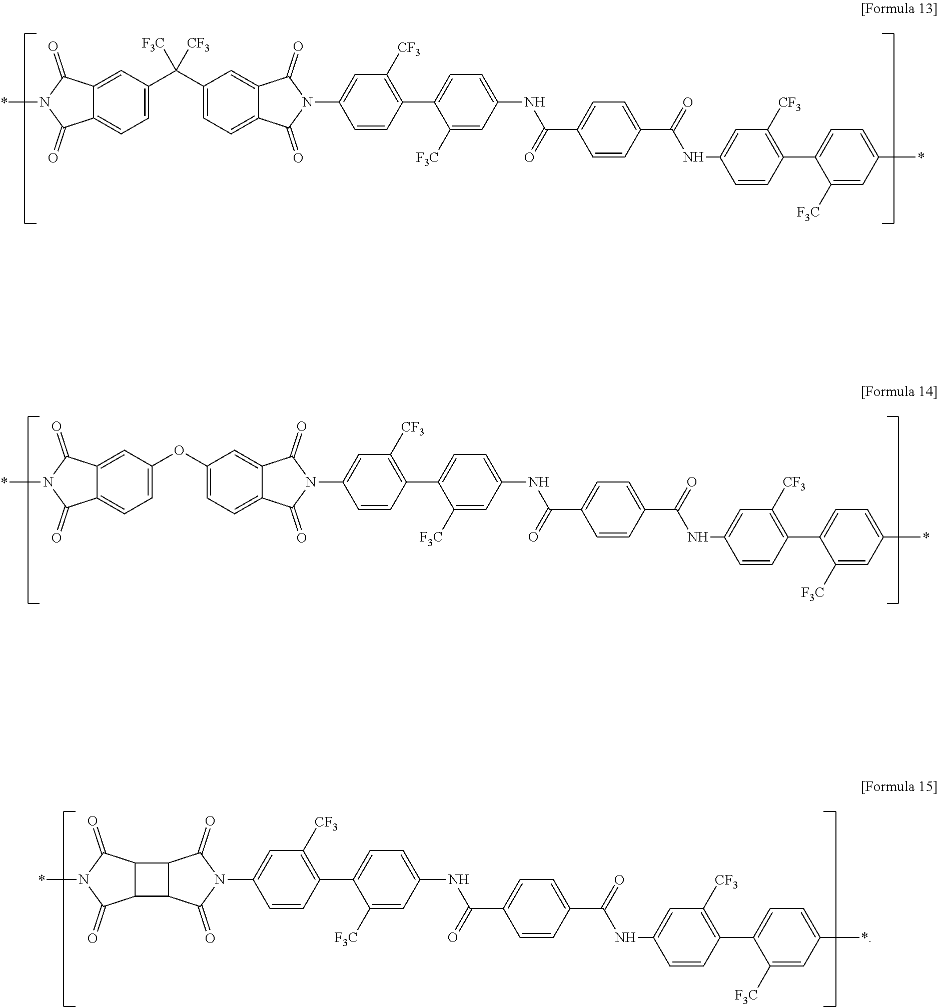

11. The optical film according to claim 1, wherein the first polymerization structure is formed by polymerization of the dianhydride compound and a diamine compound represented by the following Formula 16:

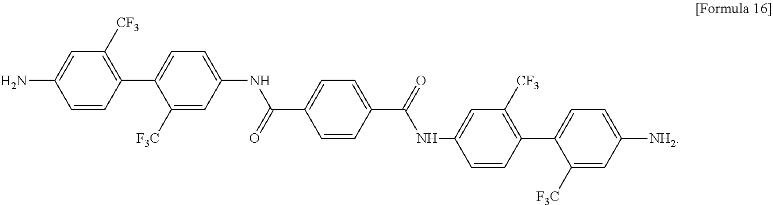 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

12. The optical film according to claim 1, wherein the optical film comprises 100 ppb (parts per billion) by weight or less of chlorine (Cl).

13. The optical film according to claim 1, wherein the optical film has a light transmittance of 88% or more based on a thickness of 50 μm.

14. The optical film according to claim 1, wherein the optical film has a yellowness index of 4 or less based on a thickness of 50 μm.

15. The optical film according to claim 1, wherein the polymer has a polydispersity index (PDI) of 1.5 to 3.0.

16. A display device comprising the optical film according to claim 1.

17. A polymer comprising a first polymerization structure represented by the following Formula 1: 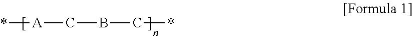
wherein A is a group derived from a dianhydride compound;
B is a group derived from a dicarbonyl compound;
C is a group derived from a diamine compound; and
n represents a number of repetitions of *-A-C—B—C—*, which is a repeating unit, and is an integer of 5 or more.

18. The polymer according to claim 17, wherein n is an integer of 10 or more.

19. The polymer according to claim 17, wherein a content of the first polymerization structure is 5% by weight or more based on a total weight of the polymer.

20. The polymer according to claim 17, wherein the content of the first polymerization structure is 10% by weight or more based on a total weight of the polymer.

21. The polymer according to claim 17, wherein the dicarbonyl compound comprises at least one selected from terephthaloyl dichloride (TPC), isophthaloyl chloride (IPC), naphthalene-2,6-dicarbonyl dichloride, naphthalene-2,3-dicarbonyl dichloride, 1,1′-biphenyl-4,4′-dicarbonyl dichloride, 1,1′-biphenyl-3,3′-dicarbonyl dichloride, and 4,4′-oxydibenzoylchloride (ODBC).

22. The polymer according to claim 17, wherein the diamine compound comprises at least one selected from 2,2′-bis(trifluoromethyl)benzidine (TFDB), oxydianiline (ODA), p-phenylenediamine (pPDA), m-phenylenediamine (mPDA), 4,4-methylenedianiline (pMDA), 3,3-methylenedianiline (mMDA), 1,3-bis(3-aminophenoxy)benzene (133APB), 1,3-bis(4-aminophenoxy)benzene (134APB), bisaminophenoxy phenyl hexafluoropropane (4BDAF), 2,2′-bis(3-aminophenyl) hexafluoropropane (33-6F), 2,2′-bis(4-aminophenyl) hexafluoropropane (44-6F), bis(4-aminophenyl)sulfone (4DDS), bis(3-aminophenyl)sulfone (3DDS), 1,3-cyclohexanediamine (13CHD), 1,4-cyclohexanediamine (14CHD), 2,2-bis(4-(4-aminophenoxy)phenyl)propane (6HMDA), 2,2-bis(3-amino-4-hydroxyphenyl)hexafluoropropane (DBOH), bis(4-(4-aminophenoxy)phenyl)sulfone, bis(4-(3-aminophenoxy)phenyl)sulfone, 9,9-bis(4-aminophenyl)fluorene (FDA), and 9,9-bis(4-amino-3-fluorophenyl)fluorene (F-FDA).

23. The polymer according to claim 17, wherein the dianhydride compound comprises at least one selected from 2,2-bis(3,4-dicarboxyphenyl)hexafluoropropane dianhydride (6FDA), 3,3′,4,4′-biphenyltetracarboxylic dianhydride (BPDA), 4-(2,5-dioxotetrahydrofuran-3-yl)-1,2,3,4-tetrahydronaphthalene-1,2-dicarboxylic anhydride (TDA), pyromellitic dianhydride (PMDA), benzophenone tetracarboxylic dianhydride (BTDA), 4,4′-oxydiphthalic anhydride (ODPA), 4,4′-bis(3,4-dicarboxyphenoxy)-diphenyl sulfide dianhydride (BDSDA), 3,3′,4,4′-diphenylsulfonetetracarboxylic dianhydride (SO₂DPA), 4,4′-(4,4′-isopropylidenediphenoxy)bis(phthalic anhydride) (6HBDA), cyclobutane-1,2,3,4-tetracarboxylic dianhydride (CBDA), 1,2,3,4-cyclopentane-tetracarboxylic dianhydride (CPDA), 1,2,4,5-cyclohexane-tetracarboxylic dianhydride (CHDA), and dicyclohexyl-3,4,3′,4′-tetracarboxylic dianhydride (HBPDA).

24. The polymer according to claim 17, wherein the first polymerization structure comprises a repeating unit represented by the following Formula 2: 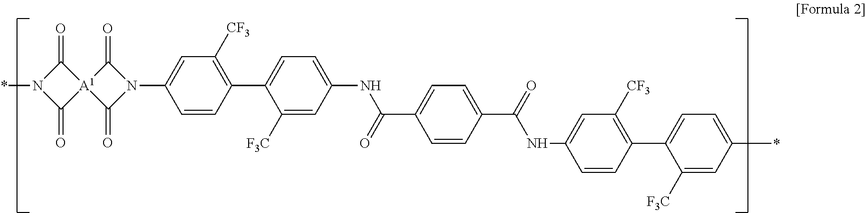
wherein A¹ represents a tetravalent organic group.

25. The polymer according to claim 24, wherein A¹ is represented by at least one of the following Formulas 3 to 12: 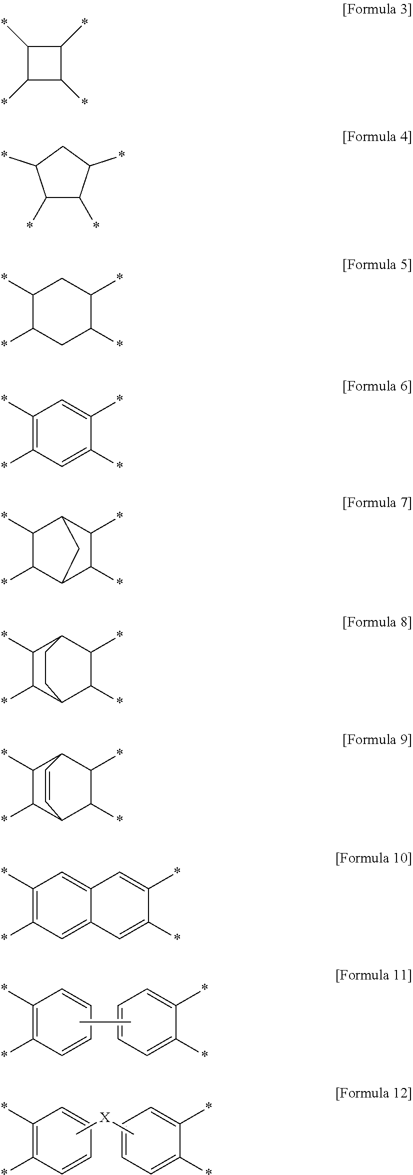
wherein X represents any one of —O—, —S—, —SO₂—, —CO—, —(CH₂)—, —C(CH₃)₂—, and —C(CF₃)₂—.

26. The polymer according to claim 17, wherein the first polymerization structure comprises a repeating unit represented by any one of the following Formulas 13, 14, and 15:

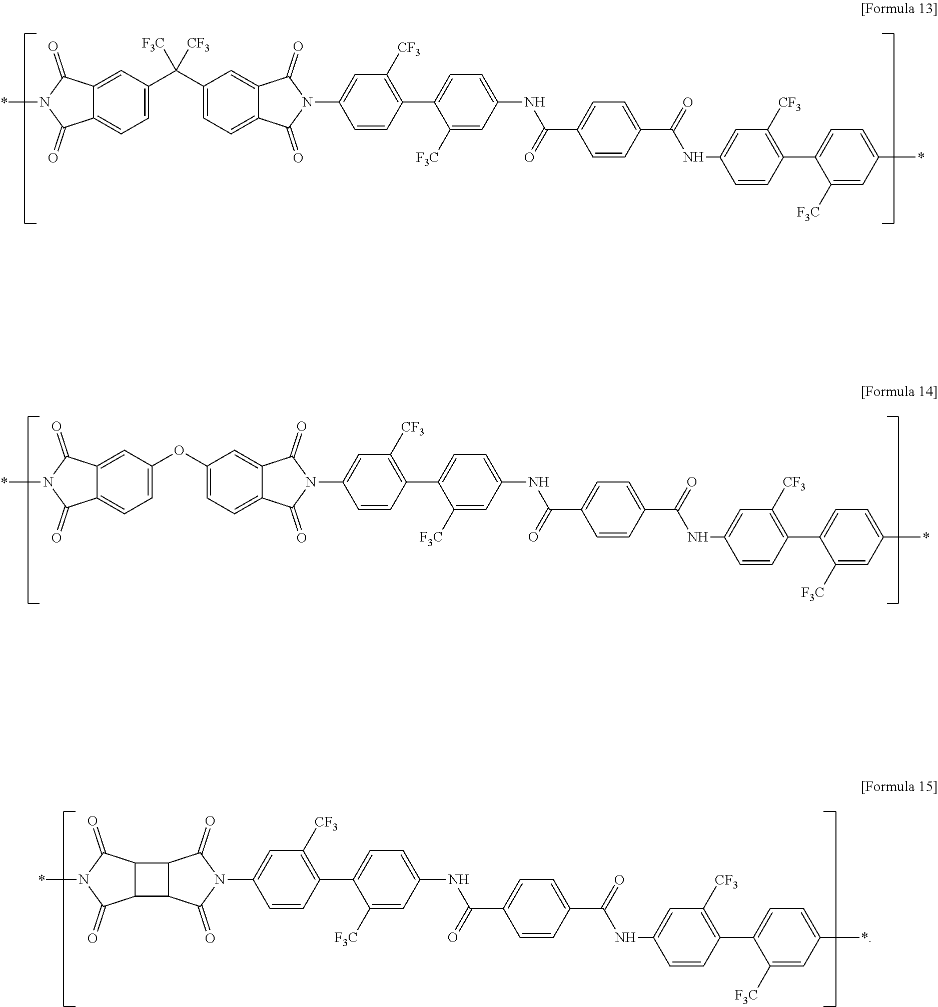

27. The polymer according to claim 17, wherein the first polymerization structure is formed by polymerization of the dianhydride compound and a diamine compound represented by the following Formula 16:

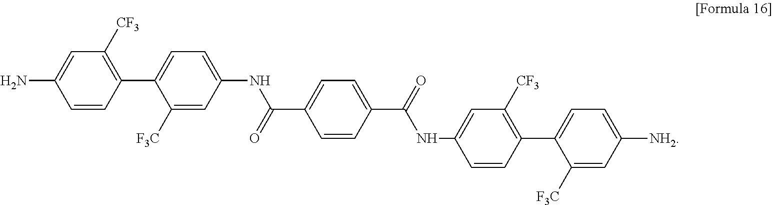 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]

28. The polymer according to claim 17, wherein the polymer has a polydispersity index (PDI) of 1.5 to 3.0.

29. A polymer resin comprising the polymer according to claim 17.

30. The polymer resin according to claim 29, wherein the polymer comprises 100 ppb (parts per billion) or less of chlorine (Cl) based on a total weight of the polymer resin.

31. A polyamide-imide precursor comprising a repeating unit represented by the following Formula 18: 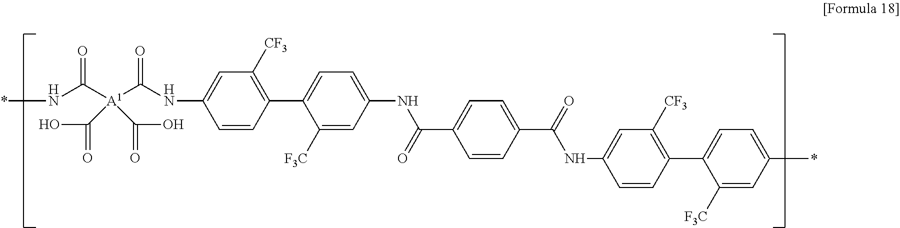
wherein A¹ represents a tetravalent organic group.

32. The polyamide-imide precursor according to claim 31, wherein A¹ is represented by at least one of the following Formulas 3 to 12: 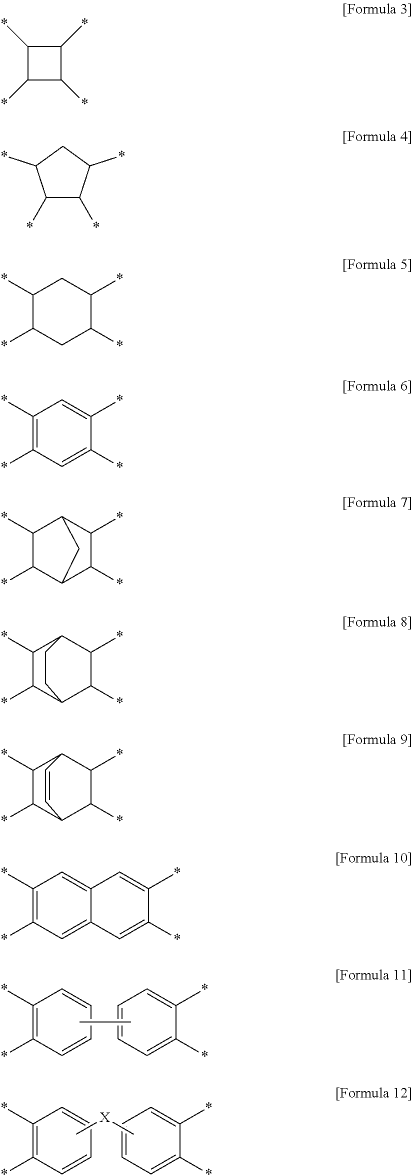
wherein X represents any one of —O—, —S—, —SO₂—, —CO—, —(CH₂)—, —C(CH₃)₂—, and —C(CF₃)₂—.

33. The polyamide-imide precursor according to claim 31, wherein the repeating unit is represented by any one of the following Formulas 19, 20 and 21:

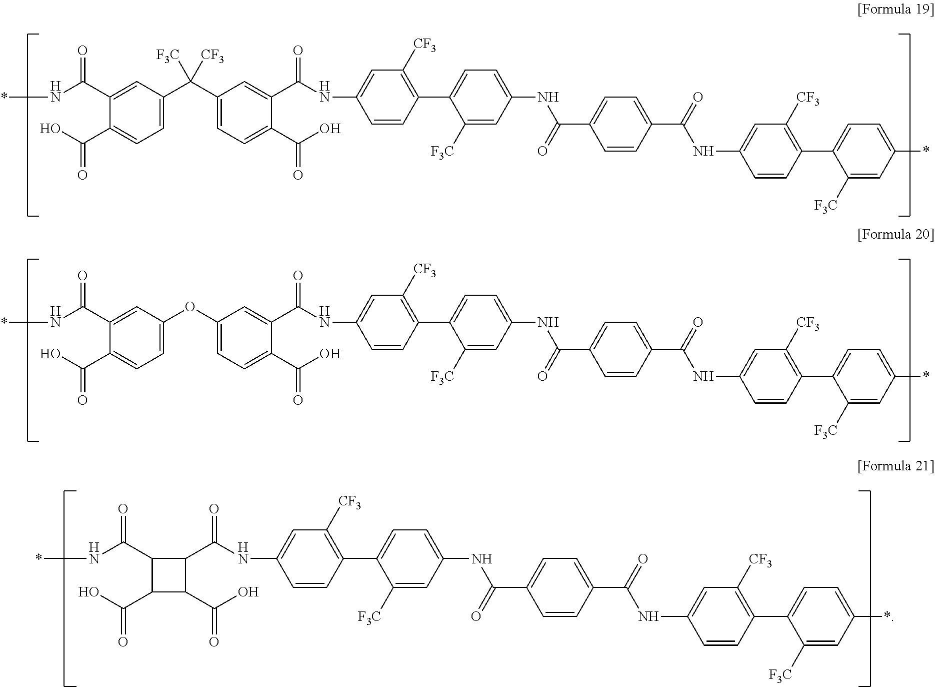

34. The polyamide-imide precursor according to claim 31, wherein the polyamide-imide precursor is formed by polymerization of a dianhydride compound and a diamine compound represented by the following Formula 16: 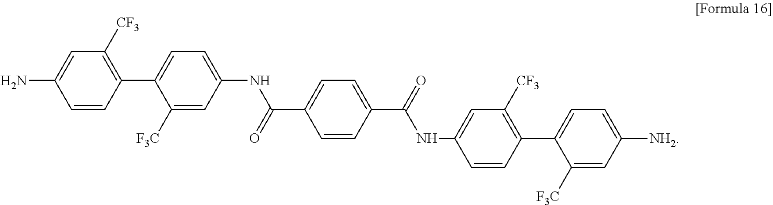 [SMILES: Nc1ccc(-c2ccc(NC(=O)c3ccc(C(=O)Nc4ccc(-c5ccc(N)cc5C(F)(F)F)c(C(F)(F)F)c4)cc3)cc2C(F)(F)F)c(C(F)(F)F)c1]
